(19) United States
(12) Patent Application Publication
(10) Pub. No.: US 2024/0214179 A1
(43) Pub. Date: Jun. 27, 2024

(54) BLOCKCHAIN-IMPLEMENTED HASH FUNCTION

(71) Applicant: nChain Licensing AG, Zug (CH)

(72) Inventors: Craig Steven WRIGHT, London (GB); Wei ZHANG, London (GB); Alec BURNS, London (GB)

(21) Appl. No.: 18/286,087

(22) PCT Filed: Mar. 7, 2022
(86) PCT No.: PCT/EP2022/055704

§ 371 Date: Oct. 6, 2023

(30) Foreign Application Priority Data
Apr. 7, 2021 (GB) 2104938.2
Feb. 15, 2022 (GB) 2201957.4

(51) Int. Cl. H04L 9/06; H04L 9/00; H04L 9/30

(52) U.S. Cl. CPC H04L 9/0643; H04L 9/30; H04L 9/50

(57) ABSTRACT

A computer-implemented method of implementing a hash function (HF) using blockchain transactions, wherein the method is performed by a first party and comprises: generating a first blockchain transaction; and submitting the first blockchain transaction to one or more nodes of a blockchain transaction, wherein the first blockchain transaction comprises a locking script configured to, when executed together with an unlocking script of a second blockchain transaction comprising a target data item, generate a hash result of the target data item.

### CROSS REFERENCE TO RELATED APPLICATIONS

This application is the U.S. National Stage of International Application No. PCT/EP2022/055704 filed on Mar. 7, 2022, which claims the benefit of United Kingdom Patent Application No. 2104938.2, filed on Apr. 7, 2021 and United Kingdom Patent Application No. 2201957.4, filed on Feb. 15, 2022, the contents of which are incorporated herein by reference in their entireties.

### TECHNICAL FIELD

The present disclosure relates to a method for implementing a hash function using blockchain transactions.

### BACKGROUND

A blockchain refers to a form of distributed data structure, wherein a duplicate copy of the blockchain is maintained at each of a plurality of nodes in a distributed peer-to-peer (P2P) network (referred to below as a “blockchain network”) and widely publicised. The blockchain comprises a chain of blocks of data, wherein each block comprises one or more transactions. Each transaction, other than so-called “coinbase transactions”, points back to a preceding transaction in a sequence which may span one or more blocks going back to one or more coinbase transactions. Coinbase transactions are discussed further below. Transactions that are submitted to the blockchain network are included in new blocks. New blocks are created by a process often referred to as “mining”, which involves each of a plurality of the nodes competing to perform “proof-of-work”, i.e. solving a cryptographic puzzle based on a representation of a defined set of ordered and validated pending transactions waiting to be included in a new block of the blockchain. It should be noted that the blockchain may be pruned at some nodes, and the publication of blocks can be achieved through the publication of mere block headers.

The transactions in the blockchain may be used for one or more of the following purposes: to convey a digital asset (i.e. a number of digital tokens), to order a set of entries in a virtualised ledger or registry, to receive and process timestamp entries, and/or to time-order index pointers. A blockchain can also be exploited in order to layer additional functionality on top of the blockchain. For example blockchain protocols may allow for storage of additional user data or indexes to data in a transaction. There is no pre-specified limit to the maximum data capacity that can be stored within a single transaction, and therefore increasingly more complex data can be incorporated. For instance this may be used to store an electronic document in the blockchain, or audio or video data.

Nodes of the blockchain network (which are often referred to as “miners”) perform a distributed transaction registration and verification process, which will be described in more detail later. In summary, during this process a node validates transactions and inserts them into a block template for which they attempt to identify a valid proof-of-work solution. Once a valid solution is found, a new block is propagated to other nodes of the network, thus enabling each node to record the new block on the blockchain. In order to have a transaction recorded in the blockchain, a user (e.g. a blockchain client application) sends the transaction to one of the nodes of the network to be propagated. Nodes which receive the transaction may race to find a proof-of-work solution incorporating the validated transaction into a new block. Each node is configured to enforce the same node protocol, which will include one or more conditions for a transaction to be valid. Invalid transactions will not be propagated nor incorporated into blocks. Assuming the transaction is validated and thereby accepted onto the blockchain, then the transaction (including any user data) will thus remain registered and indexed at each of the nodes in the blockchain network as an immutable public record.

The node who successfully solved the proof-of-work puzzle to create the latest block is typically rewarded with a new transaction called the “coinbase transaction” which distributes an amount of the digital asset, i.e. a number of tokens. The detection and rejection of invalid transactions is enforced by the actions of competing nodes who act as agents of the network and are incentivised to report and block malfeasance. The widespread publication of information allows users to continuously audit the performance of nodes. The publication of the mere block headers allows participants to ensure the ongoing integrity of the blockchain.

In an “output-based” model (sometimes referred to as a UTXO-based model), the data structure of a given transaction comprises one or more inputs and one or more outputs. Any spendable output comprises an element specifying an amount of the digital asset that is derivable from the proceeding sequence of transactions. The spendable output is sometimes referred to as a UTXO (“unspent transaction output”). The output may further comprise a locking script specifying a condition for the future redemption of the output. A locking script is a predicate defining the conditions necessary to validate and transfer digital tokens or assets. Each input of a transaction (other than a coinbase transaction) comprises a pointer (i.e. a reference) to such an output in a preceding transaction, and may further comprise an unlocking script for unlocking the locking script of the pointed-to output. So consider a pair of transactions, call them a first and a second transaction (or “target” transaction). The first transaction comprises at least one output specifying an amount of the digital asset, and comprising a locking script defining one or more conditions of unlocking the output. The second, target transaction comprises at least one input, comprising a pointer to the output of the first transaction, and an unlocking script for unlocking the output of the first transaction.

In such a model, when the second, target transaction is sent to the blockchain network to be propagated and recorded in the blockchain, one of the criteria for validity applied at each node will be that the unlocking script meets all of the one or more conditions defined in the locking script of the first transaction. Another will be that the output of the first transaction has not already been redeemed by another, earlier valid transaction. Any node that finds the target transaction invalid according to any of these conditions will not propagate it (as a valid transaction, but possibly to register an invalid transaction) nor include it in a new block to be recorded in the blockchain.

An alternative type of transaction model is an account-based model. In this case each transaction does not define the amount to be transferred by referring back to the UTXO of a preceding transaction in a sequence of past transactions, but rather by reference to an absolute account balance. The current state of all accounts is stored by the nodes separate to the blockchain and is updated constantly.

### SUMMARY

A hash function is a function that takes an input of arbitrary length and gives an output of fixed length. There are two general uses of hash functions. One use is to convert key-value pairs to index-value pairs for table lookup, in which case keys are hashed to indices. Multiplicative hashing is commonly used in programming for this purpose. The other major use is in cryptography, in which case the hash functions are generally referred to as cryptographic hash functions. In this case, security requirements result in more complicated hash functions. As an example, SHA256 is a cryptographic hash function used in blockchain technology.

Cryptographic hash functions, such as SHA256, are frequently used in locking scripts of blockchain transactions. For example, a well-known locking script is the pay-to-public-key-hash (P2PKH) locking script which uses the OP_HASH160 opcode discussed below.

Most blockchains, e.g. Bitcoin, have a limited scripting language which consists of a limited number of functions, i.e. operators. For instance, in Bitcoin these functions are known as opcodes. At the time of writing, the Bitcoin scripting language (Script) is limited to just five opcodes that can be used to implement a hash function. OP_RIPEMD160 is an opcode configured to hash an input using the RIPEMD-160 hash function. OP_SHA1 is an opcode configured to hash an input using the SHA-1 hash function. OP_SHA256 is an opcode configured to hash an input using the SHA-256 hash function. OP_HASH160 is an opcode configured to first hash an input using the SHA-256 hash function and then with the RIPEMD-160 hash function. Finally, OP_HASH256 is an opcode configured to hash an input twice using the SHA-256 hash function. See, for example, wiki.bitcoinsv.io/index.php/Opcodes_used_in_Bitcoin_Script. Other blockchains are similarly limited. There are many scenarios where it would be beneficial to use a hash function that is not limited to those that are implemented by the existing set of opcodes.

However it is not desirable to introduce new opcodes as this would undermine the stability of the blockchain and reduce its trustworthiness. It would therefore be desirable to expand the range of hash functions that can be implemented, in script, using the existing set of opcodes (or functions more generally).

Moreover, some of the available opcodes (e.g. OP_HASH256) involve applying several cryptographic hash functions to an input and are thus computationally expensive. It would therefore be desirable to be able to implement a hash function that is less computationally expensive than those that involve multiple cryptographic hash operations.

According to one aspect disclosed herein, there is provided a computer-implemented method of implementing a hash function, HF, using blockchain transactions, wherein the method is performed by a first party and comprises: generating a first blockchain transaction; and submitting the first blockchain transaction to one or more nodes of a blockchain transaction, wherein the first blockchain transaction comprises a locking script configured to, when executed together with an unlocking script of a second blockchain transaction comprising a target data item, generate a hash result of the target data item, wherein the locking script comprises a HF script configured to generate the hash result by performing at least the steps of: generating a first intermediate result based on a multiplication of the target data item by a first parameter, generating a second intermediate result based on an addition of a second parameter to the first intermediate result, generating a third intermediate result based on a modulo of the second intermediate result by a third parameter; and generating the hash result based on a modulo of the third intermediate result by a fourth parameter.

Universal hashing refers to an algorithm that selects a hash function from a set of hash functions, then calculates the output based on the selected hash function, for any given input. The main goals for universal hashing are to reduce the likelihood of collisions and to avoid worst case inputs (for some hash functions, there exists a set of worst-case inputs for which it would take much longer than average to compute their hash values).

The hash function (HF) script of the first blockchain transaction is configured to implement a hash function. In some embodiments, the hash function involves multiplying an input by a first parameter (a), adding a second parameter (b), taking mod p, and then taking mod n. In some examples, other (minor) operations may be performed. Thus HF script is configured to implement a new hash function compared to those currently available as part of the blockchain's primitive scripting language. In addition, the HF script is computationally less computationally expensive compared to the existing hash functions offered on some blockchains (e.g. OP_HASH160).

In some embodiments, the HF script is used as part of a P2PKH script instead of the OP_HASH160 opcode, and therefore achieves the same result (locking an output to a public key hash) with less computation.

In some embodiments, a plurality of different blockchain addresses may be generated from the same public key using the universal hash function. Each address may be used to lock a different output of a transaction, and/or to lock different outputs of different transactions. Each different output may include an instance of the HF script, with each instance including (and therefore being locked to) a different one of the addresses.

### BRIEF DESCRIPTION OF THE DRAWINGS

To assist understanding of embodiments of the present disclosure and to show how such embodiments may be put into effect, reference is made, by way of example only, to the accompanying drawings in which:

FIG. 1 is a schematic block diagram of a system for implementing a blockchain,

FIG. 2 schematically illustrates some examples of transactions which may be recorded in a blockchain,

FIG. 3A is a schematic block diagram of a client application,

FIG. 3B is a schematic mock-up of an example user interface that may be presented by the client application of FIG. 3A,

FIG. 4 is a schematic block diagram of some node software for processing transactions,

FIG. 5 is a schematic block diagram of an example system for submitting blockchain transactions to a blockchain,

FIG. 6 is a schematic block diagram of another example system for submitting blockchain transactions to a blockchain,

FIG. 7 schematically illustrates a hierarchical deterministic set of keys,

FIG. 8 is an example script for converting to a binary representation,

FIG. 9 is an example script for performing a point scalar multiplication,

FIG. 10 is an example script for performing an inverse modulo calculation,

FIG. 11 is an example script for performing a point addition of two different points,

FIG. 12 is an example script for performing a point addition of two same points,

FIG. 13 is an example script for performing a point addition of two points,

FIG. 14 is an example script for converting data into a compressed key format,

FIG. 15 schematically illustrates a hybrid hashing index scheme.

### DETAILED DESCRIPTION OF EMBODIMENTS

### 1. Example System Overview

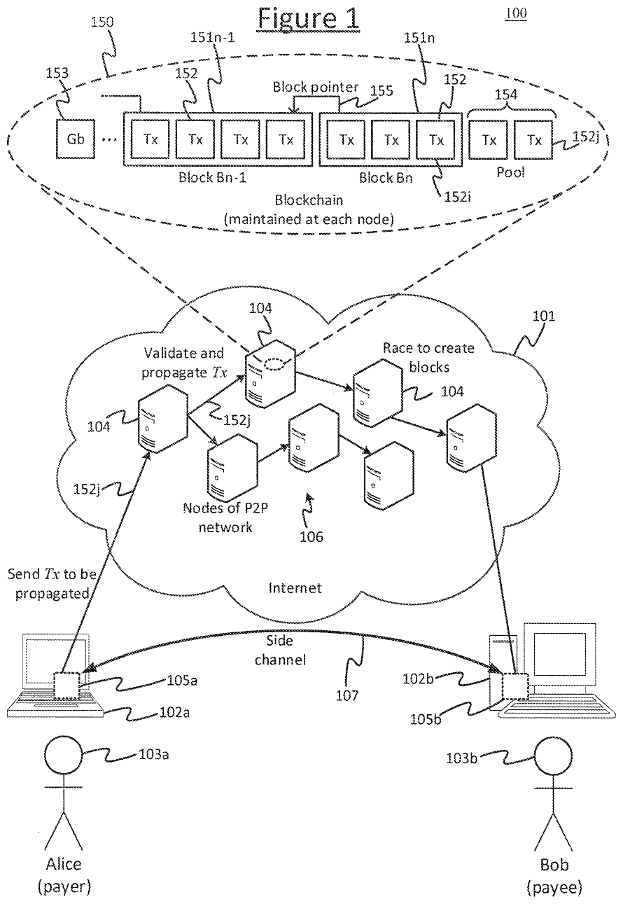

FIG. 1 shows an example system 100 for implementing a blockchain 150. The system 100 may comprise a packet-switched network 101, typically a wide-area internetwork such as the Internet. The packet-switched network 101 comprises a plurality of blockchain nodes 104 that may be arranged to form a peer-to-peer (P2P) network 106 within the packet-switched network 101. Whilst not illustrated, the blockchain nodes 104 may be arranged as a near-complete graph. Each blockchain node 104 is therefore highly connected to other blockchain nodes 104.

Each blockchain node 104 comprises computer equipment of a peer, with different ones of the nodes 104 belonging to different peers. Each blockchain node 104 comprises processing apparatus comprising one or more processors, e.g. one or more central processing units (CPUs), accelerator processors, application specific processors and/or field programmable gate arrays (FPGAs), and other equipment such as application specific integrated circuits (ASICs). Each node also comprises memory, i.e. computer-readable storage in the form of a non-transitory computer-readable medium or media. The memory may comprise one or more memory units employing one or more memory media, e.g. a magnetic medium such as a hard disk; an electronic medium such as a solid-state drive (SSD), flash memory or EEPROM; and/or an optical medium such as an optical disk drive.

The blockchain 150 comprises a chain of blocks of data 151, wherein a respective copy of the blockchain 150 is maintained at each of a plurality of blockchain nodes 104 in the distributed or blockchain network 106. As mentioned above, maintaining a copy of the blockchain 150 does not necessarily mean storing the blockchain 150 in full. Instead, the blockchain 150 may be pruned of data so long as each blockchain node 150 stores the block header (discussed below) of each block 151. Each block 151 in the chain comprises one or more transactions 152, wherein a transaction in this context refers to a kind of data structure. The nature of the data structure will depend on the type of transaction protocol used as part of a transaction model or scheme. A given blockchain will use one particular transaction protocol throughout. In one common type of transaction protocol, the data structure of each transaction 152 comprises at least one input and at least one output. Each output specifies an amount representing a quantity of a digital asset as property, an example of which is a user 103 to whom the output is cryptographically locked (requiring a signature or other solution of that user in order to be unlocked and thereby redeemed or spent). Each input points back to the output of a preceding transaction 152, thereby linking the transactions.

Each block 151 also comprises a block pointer 155 pointing back to the previously created block 151 in the chain so as to define a sequential order to the blocks 151. Each transaction 152 (other than a coinbase transaction) comprises a pointer back to a previous transaction so as to define an order to sequences of transactions (N.B. sequences of transactions 152 are allowed to branch). The chain of blocks 151 goes all the way back to a genesis block (Gb) 153 which was the first block in the chain. One or more original transactions 152 early on in the chain 150 pointed to the genesis block 153 rather than a preceding transaction.

Each of the blockchain nodes 104 is configured to forward transactions 152 to other blockchain nodes 104, and thereby cause transactions 152 to be propagated throughout the network 106. Each blockchain node 104 is configured to create blocks 151 and to store a respective copy of the same blockchain 150 in their respective memory. Each blockchain node 104 also maintains an ordered set (or “pool”) 154 of transactions 152 waiting to be incorporated into blocks 151. The ordered pool 154 is often referred to as a “mempool”. This term herein is not intended to limit to any particular blockchain, protocol or model. It refers to the ordered set of transactions which a node 104 has accepted as valid and for which the node 104 is obliged not to accept any other transactions attempting to spend the same output.

In a given present transaction 152j, the (or each) input comprises a pointer referencing the output of a preceding transaction 152i in the sequence of transactions, specifying that this output is to be redeemed or “spent” in the present transaction 152j. In general, the preceding transaction could be any transaction in the ordered set 154 or any block 151. The preceding transaction 152i need not necessarily exist at the time the present transaction 152j is created or even sent to the network 106, though the preceding transaction 152i will need to exist and be validated in order for the present transaction to be valid. Hence “preceding” herein refers to a predecessor in a logical sequence linked by pointers, not necessarily the time of creation or sending in a temporal sequence, and hence it does not necessarily exclude that the transactions 152i, 152j be created or sent out-of-order (see discussion below on orphan transactions). The preceding transaction 152i could equally be called the antecedent or predecessor transaction.

The input of the present transaction 152j also comprises the input authorisation, for example the signature of the user 103a to whom the output of the preceding transaction 152i is locked. In turn, the output of the present transaction 152j can be cryptographically locked to a new user or entity 103b. The present transaction 152j can thus transfer the amount defined in the input of the preceding transaction 152i to the new user or entity 103b as defined in the output of the present transaction 152j. In some cases a transaction 152 may have multiple outputs to split the input amount between multiple users or entities (one of whom could be the original user or entity 103a in order to give change). In some cases a transaction can also have multiple inputs to gather together the amounts from multiple outputs of one or more preceding transactions, and redistribute to one or more outputs of the current transaction.

According to an output-based transaction protocol such as bitcoin, when a party 103, such as an individual user or an organization, wishes to enact a new transaction 152j (either manually or by an automated process employed by the party), then the enacting party sends the new transaction from its computer terminal 102 to a recipient. The enacting party or the recipient will eventually send this transaction to one or more of the blockchain nodes 104 of the network 106 (which nowadays are typically servers or data centres, but could in principle be other user terminals). It is also not excluded that the party 103 enacting the new transaction 152j could send the transaction directly to one or more of the blockchain nodes 104 and, in some examples, not to the recipient. A blockchain node 104 that receives a transaction checks whether the transaction is valid according to a blockchain node protocol which is applied at each of the blockchain nodes 104. The blockchain node protocol typically requires the blockchain node 104 to check that a cryptographic signature in the new transaction 152j matches the expected signature, which depends on the previous transaction 152i in an ordered sequence of transactions 152. In such an output-based transaction protocol, this may comprise checking that the cryptographic signature or other authorisation of the party 103 included in the input of the new transaction 152j matches a condition defined in the output of the preceding transaction 152i which the new transaction assigns, wherein this condition typically comprises at least checking that the cryptographic signature or other authorisation in the input of the new transaction 152j unlocks the output of the previous transaction 152i to which the input of the new transaction is linked to. The condition may be at least partially defined by a script included in the output of the preceding transaction 152i. Alternatively it could simply be fixed by the blockchain node protocol alone, or it could be due to a combination of these. Either way, if the new transaction 152j is valid, the blockchain node 104 forwards it to one or more other blockchain nodes 104 in the blockchain network 106. These other blockchain nodes 104 apply the same test according to the same blockchain node protocol, and so forward the new transaction 152j on to one or more further nodes 104, and so forth. In this way the new transaction is propagated throughout the network of blockchain nodes 104.

In an output-based model, the definition of whether a given output (e.g. UTXO) is assigned (e.g. spent) is whether it has yet been validly redeemed by the input of another, onward transaction 152j according to the blockchain node protocol. Another condition for a transaction to be valid is that the output of the preceding transaction 152i which it attempts to redeem has not already been redeemed by another transaction. Again if not valid, the transaction 152j will not be propagated (unless flagged as invalid and propagated for alerting) or recorded in the blockchain 150. This guards against double-spending whereby the transactor tries to assign the output of the same transaction more than once. An account-based model on the other hand guards against double-spending by maintaining an account balance. Because again there is a defined order of transactions, the account balance has a single defined state at any one time.

In addition to validating transactions, blockchain nodes 104 also race to be the first to create blocks of transactions in a process commonly referred to as mining, which is supported by “proof-of-work”. At a blockchain node 104, new transactions are added to an ordered pool 154 of valid transactions that have not yet appeared in a block 151 recorded on the blockchain 150. The blockchain nodes then race to assemble a new valid block 151 of transactions 152 from the ordered set of transactions 154 by attempting to solve a cryptographic puzzle. Typically this comprises searching for a “nonce” value such that when the nonce is concatenated with a representation of the ordered pool of pending transactions 154 and hashed, then the output of the hash meets a predetermined condition. E.g. the predetermined condition may be that the output of the hash has a certain predefined number of leading zeros. Note that this is just one particular type of proof-of-work puzzle, and other types are not excluded. A property of a hash function is that it has an unpredictable output with respect to its input. Therefore this search can only be performed by brute force, thus consuming a substantive amount of processing resource at each blockchain node 104 that is trying to solve the puzzle.

The first blockchain node 104 to solve the puzzle announces this to the network 106, providing the solution as proof which can then be easily checked by the other blockchain nodes 104 in the network (once given the solution to a hash it is straightforward to check that it causes the output of the hash to meet the condition). The first blockchain node 104 propagates a block to a threshold consensus of other nodes that accept the block and thus enforce the protocol rules. The ordered set of transactions 154 then becomes recorded as a new block 151 in the blockchain 150 by each of the blockchain nodes 104. A block pointer 155 is also assigned to the new block 151n pointing back to the previously created block 151n-1 in the chain. The significant amount of effort, for example in the form of hash, required to create a proof-of-work solution signals the intent of the first node 104 to follow the rules of the blockchain protocol. Such rules include not accepting a transaction as valid if it assigns the same output as a previously validated transaction, otherwise known as double-spending. Once created, the block 151 cannot be modified since it is recognized and maintained at each of the blockchain nodes 104 in the blockchain network 106. The block pointer 155 also imposes a sequential order to the blocks 151. Since the transactions 152 are recorded in the ordered blocks at each blockchain node 104 in a network 106, this therefore provides an immutable public ledger of the transactions.

Note that different blockchain nodes 104 racing to solve the puzzle at any given time may be doing so based on different snapshots of the pool of yet-to-be published transactions 154 at any given time, depending on when they started searching for a solution or the order in which the transactions were received. Whoever solves their respective puzzle first defines which transactions 152 are included in the next new block 151n and in which order, and the current pool 154 of unpublished transactions is updated. The blockchain nodes 104 then continue to race to create a block from the newly-defined ordered pool of unpublished transactions 154, and so forth. A protocol also exists for resolving any “fork” that may arise, which is where two blockchain nodes 104 solve their puzzle within a very short time of one another such that a conflicting view of the blockchain gets propagated between nodes 104. In short, whichever prong of the fork grows the longest becomes the definitive blockchain 150. Note this should not affect the users or agents of the network as the same transactions will appear in both forks.

According to the bitcoin blockchain (and most other blockchains) a node that successfully constructs a new block 104 is granted the ability to newly assign an additional, accepted amount of the digital asset in a new special kind of transaction which distributes an additional defined quantity of the digital asset (as opposed to an inter-agent, or inter-user transaction which transfers an amount of the digital asset from one agent or user to another). This special type of transaction is usually referred to as a “coinbase transaction”, but may also be termed an “initiation transaction” or “generation transaction”. It typically forms the first transaction of the new block 151n. The proof-of-work signals the intent of the node that constructs the new block to follow the protocol rules allowing this special transaction to be redeemed later. The blockchain protocol rules may require a maturity period, for example 100 blocks, before this special transaction may be redeemed. Often a regular (non-generation) transaction 152 will also specify an additional transaction fee in one of its outputs, to further reward the blockchain node 104 that created the block 151n in which that transaction was published. This fee is normally referred to as the “transaction fee”, and is discussed blow.

Due to the resources involved in transaction validation and publication, typically at least each of the blockchain nodes 104 takes the form of a server comprising one or more physical server units, or even whole a data centre. However in principle any given blockchain node 104 could take the form of a user terminal or a group of user terminals networked together.

The memory of each blockchain node 104 stores software configured to run on the processing apparatus of the blockchain node 104 in order to perform its respective role or roles and handle transactions 152 in accordance with the blockchain node protocol. It will be understood that any action attributed herein to a blockchain node 104 may be performed by the software run on the processing apparatus of the respective computer equipment. The node software may be implemented in one or more applications at the application layer, or a lower layer such as the operating system layer or a protocol layer, or any combination of these.

Also connected to the network 101 is the computer equipment 102 of each of a plurality of parties 103 in the role of consuming users. These users may interact with the blockchain network 106 but do not participate in validating transactions or constructing blocks. Some of these users or agents 103 may act as senders and recipients in transactions. Other users may interact with the blockchain 150 without necessarily acting as senders or recipients. For instance, some parties may act as storage entities that store a copy of the blockchain 150 (e.g. having obtained a copy of the blockchain from a blockchain node 104).

Some or all of the parties 103 may be connected as part of a different network, e.g. a network overlaid on top of the blockchain network 106. Users of the blockchain network (often referred to as “clients”) may be said to be part of a system that includes the blockchain network 106; however, these users are not blockchain nodes 104 as they do not perform the roles required of the blockchain nodes. Instead, each party 103 may interact with the blockchain network 106 and thereby utilize the blockchain 150 by connecting to (i.e. communicating with) a blockchain node 106. Two parties 103 and their respective equipment 102 are shown for illustrative purposes: a first party 103a and his/her respective computer equipment 102a, and a second party 103b and his/her respective computer equipment 102b. It will be understood that many more such parties 103 and their respective computer equipment 102 may be present and participating in the system 100, but for convenience they are not illustrated. Each party 103 may be an individual or an organization. Purely by way of illustration the first party 103a is referred to herein as Alice and the second party 103b is referred to as Bob, but it will be appreciated that this is not limiting and any reference herein to Alice or Bob may be replaced with “first party” and “second “party” respectively.

The computer equipment 102 of each party 103 comprises respective processing apparatus comprising one or more processors, e.g. one or more CPUs, GPUs, other accelerator processors, application specific processors, and/or FPGAs. The computer equipment 102 of each party 103 further comprises memory, i.e. computer-readable storage in the form of a non-transitory computer-readable medium or media. This memory may comprise one or more memory units employing one or more memory media, e.g. a magnetic medium such as hard disk; an electronic medium such as an SSD, flash memory or EEPROM; and/or an optical medium such as an optical disc drive. The memory on the computer equipment 102 of each party 103 stores software comprising a respective instance of at least one client application 105 arranged to run on the processing apparatus. It will be understood that any action attributed herein to a given party 103 may be performed using the software run on the processing apparatus of the respective computer equipment 102. The computer equipment 102 of each party 103 comprises at least one user terminal, e.g. a desktop or laptop computer, a tablet, a smartphone, or a wearable device such as a smartwatch. The computer equipment 102 of a given party 103 may also comprise one or more other networked resources, such as cloud computing resources accessed via the user terminal.

The client application 105 may be initially provided to the computer equipment 102 of any given party 103 on suitable computer-readable storage medium or media, e.g. downloaded from a server, or provided on a removable storage device such as a removable SSD, flash memory key, removable EEPROM, removable magnetic disk drive, magnetic floppy disk or tape, optical disk such as a CD or DVD ROM, or a removable optical drive, etc.

The client application 105 comprises at least a “wallet” function. This has two main functionalities. One of these is to enable the respective party 103 to create, authorise (for example sign) and send transactions 152 to one or more bitcoin nodes 104 to then be propagated throughout the network of blockchain nodes 104 and thereby included in the blockchain 150. The other is to report back to the respective party the amount of the digital asset that he or she currently owns. In an output-based system, this second functionality comprises collating the amounts defined in the outputs of the various 152 transactions scattered throughout the blockchain 150 that belong to the party in question.

Note: whilst the various client functionality may be described as being integrated into a given client application 105, this is not necessarily limiting and instead any client functionality described herein may instead be implemented in a suite of two or more distinct applications, e.g. interfacing via an API, or one being a plug-in to the other. More generally the client functionality could be implemented at the application layer or a lower layer such as the operating system, or any combination of these. The following will be described in terms of a client application 105 but it will be appreciated that this is not limiting.

The instance of the client application or software 105 on each computer equipment 102 is operatively coupled to at least one of the blockchain nodes 104 of the network 106. This enables the wallet function of the client 105 to send transactions 152 to the network 106. The client 105 is also able to contact blockchain nodes 104 in order to query the blockchain 150 for any transactions of which the respective party 103 is the recipient (or indeed inspect other parties' transactions in the blockchain 150, since in embodiments the blockchain 150 is a public facility which provides trust in transactions in part through its public visibility). The wallet function on each computer equipment 102 is configured to formulate and send transactions 152 according to a transaction protocol. As set out above, each blockchain node 104 runs software configured to validate transactions 152 according to the blockchain node protocol, and to forward transactions 152 in order to propagate them throughout the blockchain network 106. The transaction protocol and the node protocol correspond to one another, and a given transaction protocol goes with a given node protocol, together implementing a given transaction model. The same transaction protocol is used for all transactions 152 in the blockchain 150. The same node protocol is used by all the nodes 104 in the network 106.

When a given party 103, say Alice, wishes to send a new transaction 152j to be included in the blockchain 150, then she formulates the new transaction in accordance with the relevant transaction protocol (using the wallet function in her client application 105). She then sends the transaction 152 from the client application 105 to one or more blockchain nodes 104 to which she is connected. E.g. this could be the blockchain node 104 that is best connected to Alice's computer 102. When any given blockchain node 104 receives a new transaction 152j, it handles it in accordance with the blockchain node protocol and its respective role. This comprises first checking whether the newly received transaction 152j meets a certain condition for being “valid”, examples of which will be discussed in more detail shortly. In some transaction protocols, the condition for validation may be configurable on a per-transaction basis by scripts included in the transactions 152. Alternatively the condition could simply be a built-in feature of the node protocol, or be defined by a combination of the script and the node protocol.

On condition that the newly received transaction 152j passes the test for being deemed valid (i.e. on condition that it is “validated”), any blockchain node 104 that receives the transaction 152j will add the new validated transaction 152 to the ordered set of transactions 154 maintained at that blockchain node 104. Further, any blockchain node 104 that receives the transaction 152j will propagate the validated transaction 152 onward to one or more other blockchain nodes 104 in the network 106. Since each blockchain node 104 applies the same protocol, then assuming the transaction 152j is valid, this means it will soon be propagated throughout the whole network 106.

Once admitted to the ordered pool of pending transactions 154 maintained at a given blockchain node 104, that blockchain node 104 will start competing to solve the proof-of-work puzzle on the latest version of their respective pool of 154 including the new transaction 152 (recall that other blockchain nodes 104 may be trying to solve the puzzle based on a different pool of transactions 154, but whoever gets there first will define the set of transactions that are included in the latest block 151. Eventually a blockchain node 104 will solve the puzzle for a part of the ordered pool 154 which includes Alice's transaction 152j). Once the proof-of-work has been done for the pool 154 including the new transaction 152j, it immutably becomes part of one of the blocks 151 in the blockchain 150. Each transaction 152 comprises a pointer back to an earlier transaction, so the order of the transactions is also immutably recorded.

Different blockchain nodes 104 may receive different instances of a given transaction first and therefore have conflicting views of which instance is ‘valid’ before one instance is published in a new block 151, at which point all blockchain nodes 104 agree that the published instance is the only valid instance. If a blockchain node 104 accepts one instance as valid, and then discovers that a second instance has been recorded in the blockchain 150 then that blockchain node 104 must accept this and will discard (i.e. treat as invalid) the instance which it had initially accepted (i.e. the one that has not been published in a block 151).

An alternative type of transaction protocol operated by some blockchain networks may be referred to as an “account-based” protocol, as part of an account-based transaction model. In the account-based case, each transaction does not define the amount to be transferred by referring back to the UTXO of a preceding transaction in a sequence of past transactions, but rather by reference to an absolute account balance. The current state of all accounts is stored, by the nodes of that network, separate to the blockchain and is updated constantly. In such a system, transactions are ordered using a running transaction tally of the account (also called the “position”). This value is signed by the sender as part of their cryptographic signature and is hashed as part of the transaction reference calculation. In addition, an optional data field may also be signed the transaction. This data field may point back to a previous transaction, for example if the previous transaction ID is included in the data field.

### 2. UTXO-Based Model

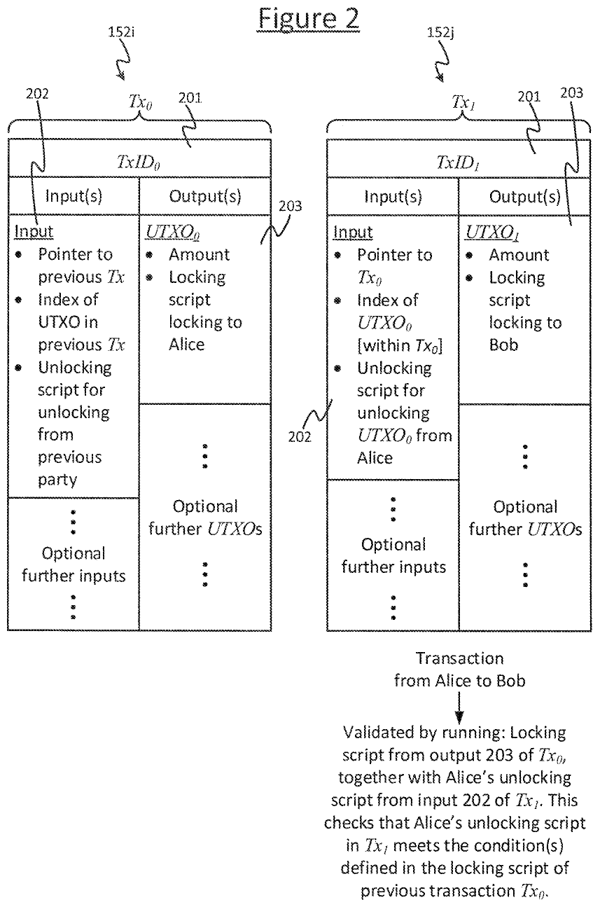

FIG. 2 illustrates an example transaction protocol. This is an example of a UTXO-based protocol. A transaction 152 (abbreviated “Tx”) is the fundamental data structure of the blockchain 150 (each block 151 comprising one or more transactions 152). The following will be described by reference to an output-based or “UTXO” based protocol. However, this is not limiting to all possible embodiments. Note that while the example UTXO-based protocol is described with reference to bitcoin, it may equally be implemented on other example blockchain networks.

In a UTXO-based model, each transaction (“Tx”) 152 comprises a data structure comprising one or more inputs 202, and one or more outputs 203. Each output 203 may comprise an unspent transaction output (UTXO), which can be used as the source for the input 202 of another new transaction (if the UTXO has not already been redeemed). The UTXO includes a value specifying an amount of a digital asset. This represents a set number of tokens on the distributed ledger. The UTXO may also contain the transaction ID of the transaction from which it came, amongst other information. The transaction data structure may also comprise a header 201, which may comprise an indicator of the size of the input field(s) 202 and output field(s) 203. The header 201 may also include an ID of the transaction. In embodiments the transaction ID is the hash of the transaction data (excluding the transaction ID itself) and stored in the header 201 of the raw transaction 152 submitted to the nodes 104.

Say Alice 103a wishes to create a transaction 152j transferring an amount of the digital asset in question to Bob 103b. In FIG. 2 Alice's new transaction 152j is labelled “Tx₁”. It takes an amount of the digital asset that is locked to Alice in the output 203 of a preceding transaction 152i in the sequence, and transfers at least some of this to Bob. The preceding transaction 152i is labelled “Tx₀” in FIG. 2. Tx₀ and Tx₁ are just arbitrary labels. They do not necessarily mean that Tx₀ is the first transaction in the blockchain 151, nor that Tx₁ is the immediate next transaction in the pool 154. Tx₁ could point back to any preceding (i.e. antecedent) transaction that still has an unspent output 203 locked to Alice.

The preceding transaction Tx₀ may already have been validated and included in a block 151 of the blockchain 150 at the time when Alice creates her new transaction Tx₁, or at least by the time she sends it to the network 106. It may already have been included in one of the blocks 151 at that time, or it may be still waiting in the ordered set 154 in which case it will soon be included in a new block 151. Alternatively Tx₀ and Tx₁ could be created and sent to the network 106 together, or Tx₀ could even be sent after Tx₁ if the node protocol allows for buffering “orphan” transactions. The terms “preceding” and “subsequent” as used herein in the context of the sequence of transactions refer to the order of the transactions in the sequence as defined by the transaction pointers specified in the transactions (which transaction points back to which other transaction, and so forth). They could equally be replaced with “predecessor” and “successor”, or “antecedent” and “descendant”, “parent” and “child”, or such like. It does not necessarily imply an order in which they are created, sent to the network 106, or arrive at any given blockchain node 104. Nevertheless, a subsequent transaction (the descendent transaction or “child”) which points to a preceding transaction (the antecedent transaction or “parent”) will not be validated until and unless the parent transaction is validated. A child that arrives at a blockchain node 104 before its parent is considered an orphan. It may be discarded or buffered for a certain time to wait for the parent, depending on the node protocol and/or node behaviour.

One of the one or more outputs 203 of the preceding transaction Tx₀ comprises a particular UTXO, labelled here UTXO₀. Each UTXO comprises a value specifying an amount of the digital asset represented by the UTXO, and a locking script which defines a condition which must be met by an unlocking script in the input 202 of a subsequent transaction in order for the subsequent transaction to be validated, and therefore for the UTXO to be successfully redeemed. Typically the locking script locks the amount to a particular party (the beneficiary of the transaction in which it is included). I.e. the locking script defines an unlocking condition, typically comprising a condition that the unlocking script in the input of the subsequent transaction comprises the cryptographic signature of the party to whom the preceding transaction is locked.

The locking script (aka scriptPubKey) is a piece of code written in the domain specific language recognized by the node protocol. A particular example of such a language is called “Script” (capital S) which is used by the blockchain network. The locking script specifies what information is required to spend a transaction output 203, for example the requirement of Alice's signature. Unlocking scripts appear in the outputs of transactions. The unlocking script (aka scriptSig) is a piece of code written the domain specific language that provides the information required to satisfy the locking script criteria. For example, it may contain Bob's signature. Unlocking scripts appear in the input 202 of transactions.

So in the example illustrated, UTXO₀ in the output 203 of Tx₀ comprises a locking script [Checksig P_{A}] which requires a signature Sig P_{A} of Alice in order for UTXO₀ to be redeemed (strictly, in order for a subsequent transaction attempting to redeem UTXO₀ to be valid).

[Checksig P_{A}] contains a representation (i.e. a hash) of the public key P_{A} from a public-private key pair of Alice. The input 202 of Tx₁ comprises a pointer pointing back to Tx₁ (e.g. by means of its transaction ID, TxID₀, which in embodiments is the hash of the whole transaction Tx₀). The input 202 of Tx₁ comprises an index identifying UTXO₀ within Tx₀, to identify it amongst any other possible outputs of Tx₀. The input 202 of Tx₁ further comprises an unlocking script <Sig P_{A}> which comprises a cryptographic signature of Alice, created by Alice applying her private key from the key pair to a predefined portion of data (sometimes called the “message” in cryptography). The data (or “message”) that needs to be signed by Alice to provide a valid signature may be defined by the locking script, or by the node protocol, or by a combination of these.

When the new transaction Tx₁ arrives at a blockchain node 104, the node applies the node protocol. This comprises running the locking script and unlocking script together to check whether the unlocking script meets the condition defined in the locking script (where this condition may comprise one or more criteria). In embodiments this involves concatenating the two scripts:

$$〈 Sig {P}_{A} 〉 〈 {P}_{A} 〉 \vert \vert [ Checksig {P}_{A} ]$$

where “∥” represents a concatenation and “< . . . >” means place the data on the stack, and “[ . . . ]” is a function comprised by the locking script (in this example a stack-based language). Equivalently the scripts may be run one after the other, with a common stack, rather than concatenating the scripts. Either way, when run together, the scripts use the public key P_{A} of Alice, as included in the locking script in the output of Tx₀, to authenticate that the unlocking script in the input of Tx₁ contains the signature of Alice signing the expected portion of data. The expected portion of data itself (the “message”) also needs to be included in order to perform this authentication. In embodiments the signed data comprises the whole of Tx₁ (so a separate element does not need to be included specifying the signed portion of data in the clear, as it is already inherently present).

The details of authentication by public-private cryptography will be familiar to a person skilled in the art. Basically, if Alice has signed a message using her private key, then given Alice's public key and the message in the clear, another entity such as a node 104 is able to authenticate that the message must have been signed by Alice. Signing typically comprises hashing the message, signing the hash, and tagging this onto the message as a signature, thus enabling any holder of the public key to authenticate the signature. Note therefore that any reference herein to signing a particular piece of data or part of a transaction, or such like, can in embodiments mean signing a hash of that piece of data or part of the transaction.

If the unlocking script in Tx₁ meets the one or more conditions specified in the locking script of Tx₀ (so in the example shown, if Alice's signature is provided in Tx₁ and authenticated), then the blockchain node 104 deems Tx₁ valid. This means that the blockchain node 104 will add Tx₁ to the ordered pool of pending transactions 154. The blockchain node 104 will also forward the transaction Tx₁ to one or more other blockchain nodes 104 in the network 106, so that it will be propagated throughout the network 106. Once Tx₁ has been validated and included in the blockchain 150, this defines UTXO₀ from Tx₀ as spent. Note that Tx₁ can only be valid if it spends an unspent transaction output 203. If it attempts to spend an output that has already been spent by another transaction 152, then Tx₁ will be invalid even if all the other conditions are met. Hence the blockchain node 104 also needs to check whether the referenced UTXO in the preceding transaction Tx₀ is already spent (i.e. whether it has already formed a valid input to another valid transaction). This is one reason why it is important for the blockchain 150 to impose a defined order on the transactions 152. In practice a given blockchain node 104 may maintain a separate database marking which UTXOs 203 in which transactions 152 have been spent, but ultimately what defines whether a UTXO has been spent is whether it has already formed a valid input to another valid transaction in the blockchain 150.

If the total amount specified in all the outputs 203 of a given transaction 152 is greater than the total amount pointed to by all its inputs 202, this is another basis for invalidity in most transaction models. Therefore such transactions will not be propagated nor included in a block 151.

Note that in UTXO-based transaction models, a given UTXO needs to be spent as a whole. It cannot “leave behind” a fraction of the amount defined in the UTXO as spent while another fraction is spent. However the amount from the UTXO can be split between multiple outputs of the next transaction. E.g. the amount defined in UTXO₀ in Tx₀ can be split between multiple UTXOs in Tx₁. Hence if Alice does not want to give Bob all of the amount defined in UTXO₀, she can use the remainder to give herself change in a second output of Tx₁, or pay another party.

In practice Alice will also usually need to include a fee for the bitcoin node 104 that successfully includes her transaction 104 in a block 151. If Alice does not include such a fee, Tx₀ may be rejected by the blockchain nodes 104, and hence although technically valid, may not be propagated and included in the blockchain 150 (the node protocol does not force blockchain nodes 104 to accept transactions 152 if they don't want). In some protocols, the transaction fee does not require its own separate output 203 (i.e. does not need a separate UTXO). Instead any difference between the total amount pointed to by the input(s) 202 and the total amount of specified in the output(s) 203 of a given transaction 152 is automatically given to the blockchain node 104 publishing the transaction. E.g. say a pointer to UTXO₀ is the only input to Tx₁, and Tx₁ has only one output UTXO₁. If the amount of the digital asset specified in UTXO₀ is greater than the amount specified in UTXO₁, then the difference may be assigned by the node 104 that wins the proof-of-work race to create the block containing UTXO₁. Alternatively or additionally however, it is not necessarily excluded that a transaction fee could be specified explicitly in its own one of the UTXOs 203 of the transaction 152.

Alice and Bob's digital assets consist of the UTXOs locked to them in any transactions 152 anywhere in the blockchain 150. Hence typically, the assets of a given party 103 are scattered throughout the UTXOs of various transactions 152 throughout the blockchain 150. There is no one number stored anywhere in the blockchain 150 that defines the total balance of a given party 103. It is the role of the wallet function in the client application 105 to collate together the values of all the various UTXOs which are locked to the respective party and have not yet been spent in another onward transaction. It can do this by querying the copy of the blockchain 150 as stored at any of the bitcoin nodes 104.

Note that the script code is often represented schematically (i.e. not using the exact language). For example, one may use operation codes (opcodes) to represent a particular function. “OP_ . . . ” refers to a particular opcode of the Script language. As an example, OP_RETURN is an opcode of the Script language that when preceded by OP_FALSE at the beginning of a locking script creates an unspendable output of a transaction that can store data within the transaction, and thereby record the data immutably in the blockchain 150. E.g. the data could comprise a document which it is desired to store in the blockchain.

Typically an input of a transaction contains a digital signature corresponding to a public key P_{A}. In embodiments this is based on the ECDSA using the elliptic curve secp256k1. A digital signature signs a particular piece of data. In some embodiments, for a given transaction the signature will sign part of the transaction input, and some or all of the transaction outputs. The particular parts of the outputs it signs depends on the SIGHASH flag. The SIGHASH flag is usually a 4-byte code included at the end of a signature to select which outputs are signed (and thus fixed at the time of signing).

The locking script is sometimes called “scriptPubKey” referring to the fact that it typically comprises the public key of the party to whom the respective transaction is locked. The unlocking script is sometimes called “scriptSig” referring to the fact that it typically supplies the corresponding signature. However, more generally it is not essential in all applications of a blockchain 150 that the condition for a UTXO to be redeemed comprises authenticating a signature. More generally the scripting language could be used to define any one or more conditions. Hence the more general terms “locking script” and “unlocking script” may be preferred.

### 3. Side Channel

As shown in FIG. 1, the client application on each of Alice and Bob's computer equipment 102a, 120b, respectively, may comprise additional communication functionality. This additional functionality enables Alice 103a to establish a separate side channel 107 with Bob 103b (at the instigation of either party or a third party). The side channel 107 enables exchange of data separately from the blockchain network. Such communication is sometimes referred to as “off-chain” communication. For instance this may be used to exchange a transaction 152 between Alice and Bob without the transaction (yet) being registered onto the blockchain network 106 or making its way onto the chain 150, until one of the parties chooses to broadcast it to the network 106. Sharing a transaction in this way is sometimes referred to as sharing a “transaction template”. A transaction template may lack one or more inputs and/or outputs that are required in order to form a complete transaction. Alternatively or additionally, the side channel 107 may be used to exchange any other transaction related data, such as keys, negotiated amounts or terms, data content, etc.

The side channel 107 may be established via the same packet-switched network 101 as the blockchain network 106. Alternatively or additionally, the side channel 301 may be established via a different network such as a mobile cellular network, or a local area network such as a local wireless network, or even a direct wired or wireless link between Alice and Bob's devices 102a, 102b. Generally, the side channel 107 as referred to anywhere herein may comprise any one or more links via one or more networking technologies or communication media for exchanging data “off-chain”, i.e. separately from the blockchain network 106. Where more than one link is used, then the bundle or collection of off-chain links as a whole may be referred to as the side channel 107. Note therefore that if it is said that Alice and Bob exchange certain pieces of information or data, or such like, over the side channel 107, then this does not necessarily imply all these pieces of data have to be send over exactly the same link or even the same type of network.

### 4. Client Software

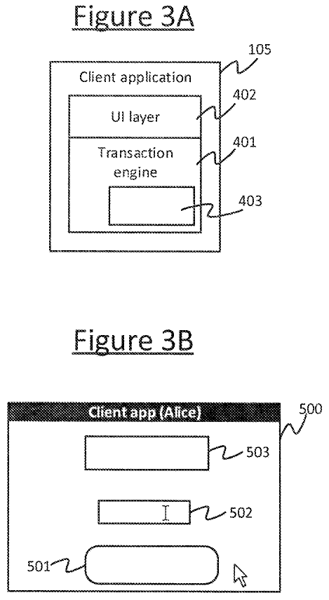

FIG. 3A illustrates an example implementation of the client application 105 for implementing embodiments of the presently disclosed scheme. The client application 105 comprises a transaction engine 401 and a user interface (UI) layer 402. The transaction engine 401 is configured to implement the underlying transaction-related functionality of the client 105, such as to formulate transactions 152, receive and/or send transactions and/or other data over the side channel 301, and/or send transactions to one or more nodes 104 to be propagated through the blockchain network 106, in accordance with the schemes discussed above and as discussed in further detail shortly.

The UI layer 402 is configured to render a user interface via a user input/output (I/O) means of the respective user's computer equipment 102, including outputting information to the respective user 103 via a user output means of the equipment 102, and receiving inputs back from the respective user 103 via a user input means of the equipment 102. For example the user output means could comprise one or more display screens (touch or non-touch screen) for providing a visual output, one or more speakers for providing an audio output, and/or one or more haptic output devices for providing a tactile output, etc. The user input means could comprise for example the input array of one or more touch screens (the same or different as that/those used for the output means); one or more cursor-based devices such as mouse, trackpad or trackball; one or more microphones and speech or voice recognition algorithms for receiving a speech or vocal input; one or more gesture-based input devices for receiving the input in the form of manual or bodily gestures; or one or more mechanical buttons, switches or joysticks, etc.

Note: whilst the various functionality herein may be described as being integrated into the same client application 105, this is not necessarily limiting and instead they could be implemented in a suite of two or more distinct applications, e.g. one being a plug-in to the other or interfacing via an API (application programming interface). For instance, the functionality of the transaction engine 401 may be implemented in a separate application than the UI layer 402, or the functionality of a given module such as the transaction engine 401 could be split between more than one application. Nor is it excluded that some or all of the described functionality could be implemented at, say, the operating system layer. Where reference is made anywhere herein to a single or given application 105, or such like, it will be appreciated that this is just by way of example, and more generally the described functionality could be implemented in any form of software.

FIG. 3B gives a mock-up of an example of the user interface (UI) 500 which may be rendered by the UI layer 402 of the client application 105a on Alice's equipment 102a. It will be appreciated that a similar UI may be rendered by the client 105b on Bob's equipment 102b, or that of any other party.

By way of illustration FIG. 3B shows the UI 500 from Alice's perspective. The UI 500 may comprise one or more UI elements 501, 502, 502 rendered as distinct UI elements via the user output means.

For example, the UI elements may comprise one or more user-selectable elements 501 which may be, such as different on-screen buttons, or different options in a menu, or such like. The user input means is arranged to enable the user 103 (in this case Alice 103a) to select or otherwise operate one of the options, such as by clicking or touching the UI element on-screen, or speaking a name of the desired option (N.B. the term “manual” as used herein is meant only to contrast against automatic, and does not necessarily limit to the use of the hand or hands).

Alternatively or additionally, the UI elements may comprise one or more data entry fields 502, through which the user can enter data. These data entry fields are rendered via the user output means, e.g. on-screen, and the data can be entered into the fields through the user input means, e.g. a keyboard or touchscreen. Alternatively the data could be received orally for example based on speech recognition.

Alternatively or additionally, the UI elements may comprise one or more information elements 503 output to output information to the user. E.g. this/these could be rendered on screen or audibly.

It will be appreciated that the particular means of rendering the various UI elements, selecting the options and entering data is not material. The functionality of these UI elements will be discussed in more detail shortly. It will also be appreciated that the UI 500 shown in FIG. 3 is only a schematized mock-up and in practice it may comprise one or more further UI elements, which for conciseness are not illustrated.

### 5. Node Software

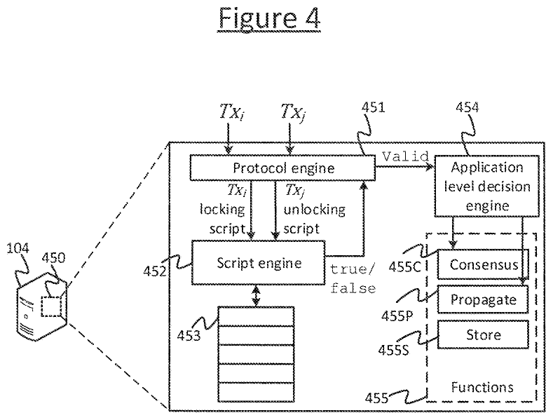

FIG. 4 illustrates an example of the node software 450 that is run on each blockchain node 104 of the network 106, in the example of a UTXO- or output-based model. Note that another entity may run node software 450 without being classed as a node 104 on the network 106, i.e. without performing the actions required of a node 104. The node software 450 may contain, but is not limited to, a protocol engine 451, a script engine 452, a stack 453, an application-level decision engine 454, and a set of one or more blockchain-related functional modules 455. Each node 104 may run node software that contains, but is not limited to, all three of: a consensus module 455C (for example, proof-of-work), a propagation module 455P and a storage module 455S (for example, a database). The protocol engine 401 is typically configured to recognize the different fields of a transaction 152 and process them in accordance with the node protocol. When a transaction 152j (Txⱼ) is received having an input pointing to an output (e.g. UTXO) of another, preceding transaction 152i (Txₘ₋₁), then the protocol engine 451 identifies the unlocking script in Txⱼ and passes it to the script engine 452. The protocol engine 451 also identifies and retrieves Txᵢ based on the pointer in the input of Txⱼ. Txᵢ may be published on the blockchain 150, in which case the protocol engine may retrieve Txᵢ from a copy of a block 151 of the blockchain 150 stored at the node 104. Alternatively, Txᵢ may yet to have been published on the blockchain 150. In that case, the protocol engine 451 may retrieve Txᵢ from the ordered set 154 of unpublished transactions maintained by the node 104. Either way, the script engine 451 identifies the locking script in the referenced output of Txᵢ and passes this to the script engine 452.

The script engine 452 thus has the locking script of Txᵢ and the unlocking script from the corresponding input of Txⱼ. For example, transactions labelled Tx₀ and Tx₁ are illustrated in FIG. 2, but the same could apply for any pair of transactions. The script engine 452 runs the two scripts together as discussed previously, which will include placing data onto and retrieving data from the stack 453 in accordance with the stack-based scripting language being used (e.g. Script).

By running the scripts together, the script engine 452 determines whether or not the unlocking script meets the one or more criteria defined in the locking script—i.e. does it “unlock” the output in which the locking script is included? The script engine 452 returns a result of this determination to the protocol engine 451. If the script engine 452 determines that the unlocking script does meet the one or more criteria specified in the corresponding locking script, then it returns the result “true”. Otherwise it returns the result “false”.

In an output-based model, the result “true” from the script engine 452 is one of the conditions for validity of the transaction. Typically there are also one or more further, protocol-level conditions evaluated by the protocol engine 451 that must be met as well; such as that the total amount of digital asset specified in the output(s) of Txⱼ does not exceed the total amount pointed to by its inputs, and that the pointed-to output of Txᵢ has not already been spent by another valid transaction. The protocol engine 451 evaluates the result from the script engine 452 together with the one or more protocol-level conditions, and only if they are all true does it validate the transaction Txⱼ. The protocol engine 451 outputs an indication of whether the transaction is valid to the application-level decision engine 454. Only on condition that Txⱼ is indeed validated, the decision engine 454 may select to control both of the consensus module 455C and the propagation module 455P to perform their respective blockchain-related function in respect of Txⱼ. This comprises the consensus module 455C adding Txⱼ to the node's respective ordered set of transactions 154 for incorporating in a block 151, and the propagation module 455P forwarding Txⱼ to another blockchain node 104 in the network 106. Optionally, in embodiments the application-level decision engine 454 may apply one or more additional conditions before triggering either or both of these functions. E.g. the decision engine may only select to publish the transaction on condition that the transaction is both valid and leaves enough of a transaction fee.

Note also that the terms “true” and “false” herein do not necessarily limit to returning a result represented in the form of only a single binary digit (bit), though that is certainly one possible implementation. More generally, “true” can refer to any state indicative of a successful or affirmative outcome, and “false” can refer to any state indicative of an unsuccessful or non-affirmative outcome. For instance in an account-based model, a result of “true” could be indicated by a combination of an implicit, protocol-level validation of a signature and an additional affirmative output of a smart contract (the overall result being deemed to signal true if both individual outcomes are true).

### 6. Definitions

### Definition 1—Multiplicative Hash:

Suppose we have a table size of 2^{m}, a modulo 2ⁿ, and an odd integer a∈{1, . . . , 2ⁿ−1}.

Then the multiplicative hash function h is defined to be

$${h}_{a} ( x ) = ⌊ ( ax mod {2}^{n} ) / {2}^{n - m} ⌋ .$$

That is, given x,
1. calculate ax mod 2ⁿ—taking the least significant n bits of ax, and
2. right-shift (n−m) bits—taking the most significant m bits of the result from step 1.

### Definition 2—Delta Function for a Hash Function

Let f: A→B be a hash function. For any two elements x, y∈A, We define

$${δ}_{f} ( x , y ) = \{ \begin{matrix}1 , & if x \neq y and f ( x ) = f ( y ) \\ 0 , & otherwise .\end{matrix}$$

### Definition 3—Delta Function for a Set of Hash Functions

Let H be a set of hash functions. We define

$${δ}_{H} ( x , y ) = {\sum }_{f ∈ H} {δ}_{f} ( x , y ) .$$

### Definition 4—Universal Hash

Let H be a set of hash functions from A to B. We say that H is universal if for all x, y in A,

$${δ}_{H} ( x , y ) \leq \vert H \vert / \vert B \vert .$$

Note that δ_{H}(x, y) counts the number of hash functions in the set that would induce a collision on x≠y, while |H|/|B| indicates the abundance of hash functions relative to the size of the range.

### Example

Let H={f: [symbol] ₘ→ [symbol] ₙ,x [symbol] ((ax+b) mod p) mod n|a∈ [symbol] ₚ/{0}, b∈ [symbol] ₚ}, where p≥m is a prime and m>n. Then H is universal.

Note that |H|=p(p−1), and |B|=n. The proof can be found in Universal Classes of Hash Functions, J. L. Carter M. N. Wegman.

### Definition 5—Cryptographic Hash

A hash function H is cryptographically secure if it is
1. pre-image resistant—given h=H(m), it is computationally difficult to find m;
2. second pre-image resistant—given h=H(m) and m, it is computationally difficult to find m′ such that H(m′)=h; and
3. collision resistant—it is computationally difficult to find a pair of messages m and m′ such that H(m)=H(m′).

### 7. In-Script Hash Function

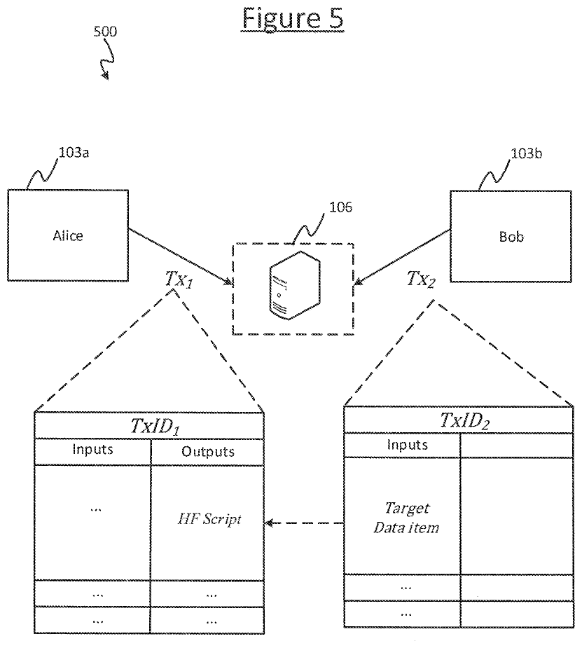

FIG. 5 illustrates an example system 500 for implementing a hash function using blockchain transactions. The system comprises a first party, e.g. Alice 103a, and a second party, e.g. Bob 103b. The system also comprises one or more nodes 104 of a blockchain network 106. Note that Alice 103a and Bob 103b are merely used as convenient labels for the first party and second party respectively, and need not necessarily be configured to perform all of the actions described as being associated with Alice 103a and Bob 103b above with reference to FIGS. 1 to 4, though that is not excluded.

As shown, Alice 103a is configured to generate a first blockchain transaction Tx1 and to submit the first blockchain transaction Tx1 to the blockchain network 106. The first blockchain transaction comprises one or more inputs and one or more outputs. At least one of the outputs (a “first output”) comprises a locking script (a “first locking script”) comprising a hash function (HF) script. Note that “first” here is used merely as a label and does not necessarily imply any form of ordering. The HF script is a portion of script configured to, when executed alongside an unlocking script of a second transaction Tx2, generate (i.e. compute, calculate, etc.) a hash (a “hash result”) of an input (a “target input”) included in the unlocking script. The target input may be any type of data item, e.g. a number, a string, etc. For example, the target input may be a public key. The first locking script may consist of the HF script, or it may comprise the HF script and one or more data items and/or additional portions of script. For example, the HF script may form part of a larger script.

In FIG. 5, the second transaction Tx2 is shown as being transmitted to the blockchain network 106 by Bob 103b. It is also not excluded that the second transaction Tx2 may be submitted to the blockchain network 106 by Alice 103a.

The HF script is configured to perform at least four mathematical operations. Each operation may be performed by a single function (e.g. opcode) of the blockchain scripting language (e.g. Bitcoin Script). Alternatively, some or all of the operations may be performed by more than one function. The first operation involves computing a first intermediate result by multiplying the target data item by a first parameter. The first operation may consist of said multiplication. Alternatively, the first operation may involve one or more additional sub-operations (e.g. addition, subtractions, etc.). The second operation involves computing a second intermediate result by adding a second parameter to the first intermediate result. The second operation may consist of said addition. The third operation involves computing a third intermediate result based on performing a first modulo operation on the second intermediate result using a third parameter. In other words, the third intermediate result is based on the remainder after dividing the second intermediate result by the third parameter. The third operation may consist of said first modulo operation. The fourth operation involves computing the hash result based on performing a second modulo operation on the third intermediate result using a fourth parameter. In other words, the fourth intermediate result is based on the remainder after dividing the third intermediate result by the fourth parameter. The fourth operation may consist of said second modulo operation. In some examples, the hash function implemented by the HF script may be referred to as a “universal hash function” because it satisfies the definition of a universal hash (Definition 4).

For instance, the HF script may take the following form:

$$〈 a 〉 OP\_MUL 〈 b 〉 OP\_ADD 〈 p 〉 OP\_MOD 〈 n 〉 OP\_MOD ,$$

where a is the first parameter, b is the second parameter, p is the third parameter and n is the fourth parameter. The skilled person will be familiar with the opcodes.

The HF script may be configured to output one, some or all of the first intermediate result, second intermediate result, third intermediate result, and fourth intermediate result. For instance, the result(s) may be output to memory. The memory may be a memory stack in the case that the scripting language is a stack-based scripting language. In some examples, only the hash result is output, e.g. to memory.

The first parameter a may be any non-zero number, and may be chosen randomly. The second parameter b may be any number, and may be chosen randomly. The third parameter p may be any positive number, e.g. a prime number, such as a prime number associated with a particular elliptic curve. For example, p may be the prime number that defines the Secp256k1 elliptic curve which is used by some blockchains. The fourth parameter n takes the form of 2^{L}, where L is chosen to define the length of the hash result. In general, L may be any suitable number, e.g. 160, 256, 512, etc. Further details of some example values of the parameters are provided further below.

In some embodiments, the first locking script may comprise an expected hash result. The expected hash result is generated by applying the universal hash function to an expected data item (e.g. an expected value). Here, “expected” means predetermined. Alice 103a may generate the expected hash result herself, or she may obtain it from elsewhere, e.g. a different party, the blockchain itself, a webpage, etc. The universal hash function is applied to the expected data item “off-chain”, i.e. not using blockchain transactions. For instance, the expected hash result may be calculated on Alice's computing equipment 105a.

The first locking script is configured to require the hash result generated by the HF script (i.e. during script execution) to match the expected hash result. That is, a condition of the unlocking script of the second transaction Tx2 unlocking the first locking script of the first blockchain transaction is that the unlocking script comprises the expected data item, and that the expected data item hashes to the expected hash result. This may be implemented using a hash puzzle. Implementing a hash puzzle, per se, will be familiar to the skilled person.

The expected data item may be an expected public key, e.g. Bob's public key PK_{B}. In this example, the expected hash result may be used as a blockchain address. As well as requiring the expected data item to be an expected public key, the first locking script may require the unlocking script of Tx2 to comprise a signature generating using a private key corresponding to the expected public key. For instance, the first locking script may require the unlocking script to comprise Bob's public key PK_{B} (which hashes to the expected hash result), and Bob's signature generated using Bob's private key sk_{B}. This form of locking script is often referred to as a pay-to-public-key-hash (P2PKH) script. Note however that the first blockchain transaction does not necessarily need to involve a payment to Bob 103b, and can in general be used for any purpose, such as sending messages to Bob 103b, storing data on the blockchain 150, etc.

For instance, the first locking script may take the following form:

$$OP\_DUP [ {UHF}_{a , b , p , n} ] 〈 {UHF}_{a , b , p , n} ( PK ) 〉 OP\_EQUALVERIFY OP\_CHECKSIG$$

where [UHF_{a,b,p,n}] is shorthand for the HF script, and <UHF_{a,b,p,n}(PK)> is the expected hash result generated by applying the universal hash function (UHF) to an expected public key.

The first locking script therefore requires the unlocking script to take the following form:

$$〈 Signature 〉 〈 PK 〉 ,$$

which is the same as the standard P2PKH script.

Until now, P2PKH scripts have taken the following form:

$$OP\_DUP OP\_HASH160 〈 HASH 160 ( PK ) 〉 OP\_EQUALVERIFY OP\_CHECKSIG$$

In this script, OP_HASH160 takes a given public key PK and outputs its hash value. The hash value is then compared with the expected hash value given in the script, <HASH160 (PK)>. HASH160 is a composite function (i.e. algorithm), which can be described as:
1. applying SHA256 to the input public key;
2. applying RIPEMD160 to the output of Step 1;
3. adding prefix to the output of Step 2 to indicate network type (mainnet, testnet, regtest);
4. applying double SHA256 to the output of Step 3;
5. taking the first 8 bytes of the output of Step 4 as the checksum;
6. adding the checksum to the output of Step 3; and
7. applying base58-encoding to the output of step 6.

Note that Step 7 is reversible. That is, given the output of Step 7, one can apply base58-decoding to work out the output of step 6. However, it is not computationally feasible to reverse all the way to obtain the input public key due to the one-way-ness of the cryptographic functions used.

The main purpose of HASH160 in the locking script is to ensure that only the expected public key will be used in the unlocking script. As it is shown above, HASH160 requires four hashes (one SHA256, one RIPEMD160 and one double SHA256). The universal hash function implemented by the HF script achieves the same result with less computation. The HF script is also much more efficient than HASH160 in a P2PKH because it only involves one multiplication, one addition and two modular operations.

Returning now to the parameters of the HF script, in some examples the third parameter p may be chosen to be the prime that comes with Secp256k1, the elliptic curve used in Bitcoin,

$${y}^{2} = {x}^{3} + 7 mod p , where$$

$$p = {2}^{256} - {2}^{32} - {2}^{9} - {2}^{8} - {2}^{7} - {2}^{6} - {2}^{4} - 1.$$

The fourth parameter may be chosen to be n=2¹⁶⁰ so that the output of the function has the same length as the output of HASH160.

The first and second parameters a and b may be chosen randomly from [symbol] ₚ by users as long as a is not zero, a, b∈_{R} [symbol] ₚ\{0}. Note that the range and the size of a affects the collision probability, which is explained below.

In the following, q is used to denote the order of the group that is defined by Secp256k1, which contains q points, where q is a prime. This implies that there are q−1 non-identity points. Since none of them has order 2 (because q is an odd prime), one can conclude that each point has its inverse that is not equal to itself. This implies that there are (q−1)/2 non-identity points with distinct x-coordinates, which can be represented as (xᵢ, ±yᵢ) for i=1, . . . , (q−1)/2.

A public key may be represented in a compressed form as (xᵢ, +) or (xᵢ, −). Note that knowing Secp256k1, one can work out what the y-coordinate can be and use the sign to identify the unique y value. We assume that xᵢ∈[0, p−1], and we use −xᵢ as the input to the universal hash function for (xᵢ, −).

This establishes the input space for the universal hash function, [symbol] ⊂ [symbol] ₘ, where m=p, and | [symbol] |=q−1. Equipped with the notations, one can make the following claim:

Given h=UHF_{a,b,p,n}(x), the probability of a randomly chosen public key x′∈ [symbol] with UHF_{a,b,p,n}(x′)=h is less than 12/n.

Note that if n=2¹⁶⁰, then the probability is less than

$$\frac{12}{{2}^{160}} ,$$

which is negligible. This implies that it can achieve collision resistance and achieve more efficiency than HASH160 by dropping the one-way-ness requirement. The one-way-ness comes naturally with the discrete logarithm problem, which will be explained in detail after the following proof.

If the public key x′∈ [symbol] is chosen randomly, then one only needs to show that the number of x′ that satisfies the equation UHF_{a,b,p,n}(x′)=h is less than | [symbol] |/n.

The equation with constraints one needs to solve is

$${ax}^{′} + b ≡ h mod p mod n , \qquad ( 1 )$$

with conditions:

$$1 \leq a \leq p - 1 \qquad ( 2 )$$

$$0 \leq b \leq p - 1 \qquad ( 3 )$$

$$0 \leq h \leq n - 1 \qquad ( 4 )$$

$$- p < {x}^{′} < p \qquad ( 5 )$$

The last inequality is the range needed for counting the number of solutions of x′. As explained earlier, the sign of x indicates which value the y-coordinate takes. The first step is to convert modular arithmetic to integer arithmetic. There exists an integer k₁ such that

$${ax}^{′} + b ≡ h + {k}_{1} n mod p \qquad ( 6 )$$

$$- p < h + {k}_{1} n < p \qquad ( 7 )$$

From (4) and (7), one has

$$- p - n < {k}_{1} n < p$$

$$- \frac{p}{n} \leq {k}_{1} < \frac{p}{n} \qquad ( 8 )$$

The number of possible values of k₁ is therefore bounded by 2p/n.

Similarly, there exists an integer k₂ such that

$${ax}^{′} + b = h + {k}_{1} n + {k}_{2} p \qquad ( 9 )$$

From (2), (3) and (5), one has:

$$- ap < {ax}^{′} + b < ap + p \qquad ( 10 )$$

Combining with (7) and (9), one has:

$$- ap - p < {k}_{2} p < ap + p \qquad ( 11 )$$

$$- a - 1 < {k}_{2} < a + 1 \qquad ( 12 )$$

(9) also implies that h−b+k₁n+k₂p is divisible by a, and can be written as

$$h - b + {k}_{1} n + {k}_{2} p ≡ 0 mod a \qquad ( 13 )$$

For any chosen value of k₁, there is k₂≡−(h−b+k₁n)p⁻¹ mod a. This gives a unique solution of k₂∈[0, a) and maximum another two solutions in [−a, a]. When k₂=0 is a solution, then a and −a are another two solutions. Given the constraint from (12), it can be concluded that the maximum number of values k₂ can take is 3. Therefore, the total number of values x′ can take is bounded by

$$\frac{2 p}{n} \times 3 = \frac{6 p}{n}$$

Therefore, the probability of a randomly chosen public key x′ that satisfies the equation UHF_{a,b,p,n}(x′)=h is bounded by

$$\frac{6 p}{n} \cdot \frac{1}{\vert 𝒟 \vert} < \frac{6 \times 2 ( q - 1 )}{n ( q - 1 )} = \frac{12}{n} .$$

The last inequality is derived from the fact that p<2q−2 and | [symbol] |=q−1, where p is the prime from Secp256k1, and q is the order of the corresponding group.

Note that, the result can be generalised by leaving the upper bound of the probability in the form

$$\frac{6 p}{n \vert 𝒟 \vert} ,$$

where p and n are the moduli in the universal hash function and | [symbol] | is the size of the input space.

Furthermore, one can justify why it can be assumed that the public key is randomly chosen. It is straightforward to calculate a public key that matches a given universal hash output. However, it is computationally infeasible to work out the private key for that public key. Therefore, in order to successfully produce a signature corresponding to a given universal hash output, one has to generate a private key first, and then check whether the corresponding public key has the matching hash value. Assuming the difficulty in discrete logarithm problem, one can say that a public key can only be randomly chosen in this context.

The above description has provided proof that using a universal hash function in place of HASH160 in script is secure in the sense that probability of collision can be negligible. Moreover, it has been justified that the one-way-ness can be effectively achieved through discrete logarithm problem from ECDSA signature. Therefore, some embodiments provide a more efficient implementation of a P2PKH script using a universal hash function.

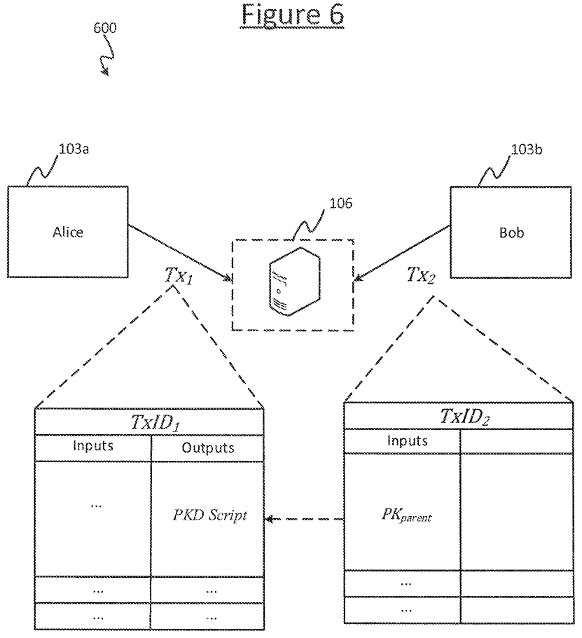

FIG. 6 illustrates an example system 600 for generating public keys in-script. In these embodiments, the first locking script of the first transaction Tx1 may comprise a public key derivation (PKD) script, and the PKD script may comprise the HF script. The PKD script is configured to, when executed, generate a child public key PK_{child} based on a parent public key PKₚₐᵣₑₙₜ included in the unlocking script of the second transaction Tx2. That is, the unlocking script of the second transaction may include a parent public key PKₚₐᵣₑₙₜ, e.g. a public key owned by Alice 103a or Bob 103b, and the PKD script is configured to compute a child public key PK_{child} of the parent public key PKₚₐᵣₑₙₜ. In these examples, the target data item comprises a chain code cₚₐᵣₑₙₜ of a parent public key, the parent public key PKₚₐᵣₑₙₜ, and an index of the child public key. The first locking script may be configured to output the child public key PK_{child}, e.g. to memory, such as a stack.

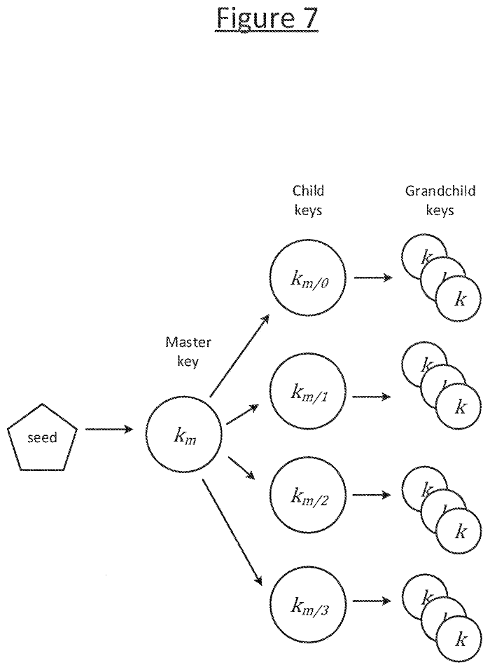

FIG. 7 illustrates an example of a hierarchical deterministic (HD) set of keys, also known as a HD wallet. Here, the master key is generated based on a seed. The child keys in each set of child keys are each generated based on the master key. The grandchild keys in each respective set of grandchild keys are each generated based on a respective set of the child keys. In this example, the master key is the parent key. However, the labels “parent” and “child” may be used to refer to a public key in an n^{th} level and public key an (n+1)^{th} level, wherein the public key in the (n+1)^{th} level is generated based on the public key in the n^{th} level.

The PKD script may be configured to generate a child public key using the following equation:

$${PK}_{child} = {PK}_{parent} + {UHF}_{a , b , p , n} ( {c}_{parent} ‖ {P}_{parent} ‖ index ) \cdot G$$

Where UHF_{a,b,p,n} is implemented by the HF script, cₚₐᵣₑₙₜ∥Pₚₐᵣₑₙₜ∥index is the target data item, and UHF_{a,b,p,n} (cₚₐᵣₑₙₜ∥Pₚₐᵣₑₙₜ∥index) is the hash result. As can be seen from the above formula, the PKD script is configured to perform point multiplication (·) of the hash result and the generator point G. The PKD script is also configured to perform point addition (+) of the parent public key with the result of that multiplication.

In some examples, the PKD script may be configured to generate a child public key using the following equation:

$${PK}_{child} = {PK}_{parent} + {UHF}_{a , b , p , {2}^{512} - L} ( {c}_{parent} ‖ {P}_{parent} ‖ index ) \cdot G$$

where UHF_{a,b,p,2}_{⁵¹²}_{-Left}(cₚₐᵣₑₙₜ∥Pₚₐᵣₑₙₜ∥index) is left 256 bytes of the hash result generated by the HF script. Note that in this example n=2⁵¹².

As an example, the PKD script may take the following pseudo form:

OP_DUP < 0x20 > OP_SPLIT OP_SWAP OP_ROT
[UHF _{a,b,p,2}⁵¹²] < 0x20 >
OP_LEFT [Hex to binary] [Point scalar multiplication] [Point addition]

where the input is the parent chain code, index and the parent public key, and the result will be the child public key, as described above.

The HF script fragment [UHF_{a,b,p,2}_{⁵¹²}] may be simply implemented as

$$〈 a 〉 OP\_MUL 〈 b 〉 OP\_ADD 〈 p 〉 OP\_MOD 〈 {n}^{512} 〉 OP\_MOD$$

where a and b are integers of at least 512 bits, and ideally p is chosen to be a multiple of n to ensure the uniform distribution of the output. [Hex to binary], [Point scalar multiplication], and [Point addition] are pseudo scripts, examples of which are provided below.

The PKD script may be used as an alternative child keys of a HD wallet. Bitcoin improvement proposal (BIP) 32 HD wallets has been widely used in the blockchain ecosystem. It offers a mechanism to derive a large number of ECDSA key pairs from a single secret seed. The key derivation algorithm uses HMAC-SHA512 to generate two strings of 256 bits from a parent chain code, a parent public key and an index, HMAC-SHA512_{L}(cₚₐᵣₑₙₜ, Pₚₐᵣₑₙₜ∥index) and HMAC-SHA512_{R}(cₚₐᵣₑₙₜ, Pₚₐᵣₑₙₜ∥index). The left 256-bit string is used in child key pair derivation, while the right 256-bit string is used as the chain code for further key pair derivations. It is not clear why HMAC-SHA512 is chosen for BIP32 other than that it offers the required bit-length of the outputs. HMAC-SHA512 is designed as a symmetric authentication scheme to ensure the authenticity and integrity of a message between parties. In the context of an HD wallet, there is no requirement of authenticity or integrity. Therefore, HMAC-SHA512 can be replaced with the universal hash function that has n=2⁵¹². This enables in-script key derivation in a hierarchical deterministic manner that was not previously feasible as SHA512 is not available as an opcode in the blockchain scripting language.

A benefit of deriving keys explicitly on chain is that a party can prove the link between two public keys that they own, and therefore there is an immutable record of that proof. This is especially useful in the context of public key infrastructure (PKI), where a single public key (e.g. an identity key) can be certified. For example, a party can prove that a public key used to sign a transaction is linked to a certified public key. By virtue of this proof of a link being on chain, related public keys can be certified by extension.

Another benefit of calculating a child public key on chain is that this child public key can be used to sign transactions but never explicitly be stored on chain. As a result, if an adversary is searching for transactions containing a given child public key, they would not find the transactions that use this method, thus increasing privacy.

Returning now to the example PKD script provided above. The first opcodes OP_DUP<0x20> OP_SPLIT OP_SWAP OP_ROT duplicate the input parent key Pₚₐᵣₑₙₜ, as the parent key is required twice in the calculation of the child key P_{child}. It then splits the copy into its x and y coordinates, which correspond to the left and right 32 bytes respectively, and places these at the bottom of the stack, as this is the required format for the final function [Point addition]. After these opcodes are executed, the state of the stack is the following:

$$\text{} \begin{matrix}〈 {P}_{parent} 〉 \\ 〈 {P}_{parent} ( x ) 〉 \\ 〈 {P}_{parent} ( y ) 〉\end{matrix} \text{}$$

The HF script fragment [UHF_{a,b,p,2}_{⁵¹²}] is then executed. After execution of this function, the state of the stack is the following:

$$\text{} \begin{matrix}〈 {UHF}_{a , b , p , {2}^{512}} ( {c}_{parent} ‖ {P}_{parent} ‖ index ) 〉 \\ 〈 {P}_{parent} ( x ) 〉 \\ 〈 {P}_{parent} ( y ) 〉\end{matrix} \text{}$$

Then the next opcodes <0x20> OP_SPLIT OP_DROP drop the right 32 bytes of the result of the HF script. The state of the stack after this point is now the following:

$$\text{} \begin{matrix}〈 {UHF}_{a , b , p , {2}^{512} - Left} ( {c}_{parent} ‖ {P}_{parent} ‖ index ) 〉 \\ 〈 {P}_{parent} ( x ) 〉 \\ 〈 {P}_{parent} ( y ) 〉\end{matrix} \text{}$$

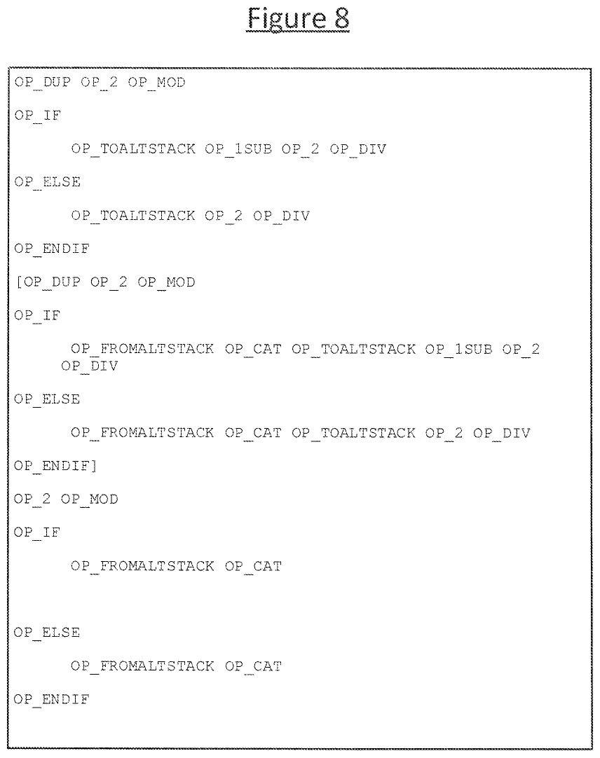

The resulting number UHF_{a,b,p,2}_{⁵¹²}_{-Left}(cₚₐᵣₑₙₜ∥Pₚₐᵣₑₙₜ∥index) is then changed from hexadecimal to binary. Note that if the hash result is already in binary, this conversion is not necessary. Next, in order to calculate the [Point scalar multiplication], the input to the function is required to be in binary, so a function (i.e. the binary conversion script) is defined to convert the hexadecimal result of the HMAC into bytes each representing a binary digit. An example script for this conversion is shown in FIG. 8.

The following is an illustrative example of the [Hex to binary] function when executed. In this example, the hexadecimal <0x07> is converted into its binary representation 0111.

In this case, n=1. The left hand columns represent the stack and the right hand columns represent the altstack. The flow of the stack is from left to right and then top to bottom.

| <0x07> | OP_DUP | <0x01> | OP_IF | <0x03> | <0x01> | OP_DUP |
|---|---|---|---|---|---|---|
| | OP_2 | <0x07> | <0x01> | | | OP_2 |
| | OP_MOD | | OP_TOALTSTACK | | | OP_MOD |
| | | | OP_1SUB OP_2 | | | |
| | | | OP_DIV | | | |
| | <0x01> | <0x01> | OP_IF <0x01> | <0x01> | OP_CAT | |
| | <0x03> | | OP_FROMALTSTACK | <0x01> | OP_TOALTSTACK | |
| | | | | <0x03> | OP_1SUB OP_2 | |
| | | | | | OP_DIV | |
| | <0x01> | <0x0101> | OP_DUP OP_2 | <0x0101> | OP_CAT | |
| | | | OP_MOD OP_IF | <0x01> | OP_TOALTSTACK | |
| | | | <0x01> | <0x01> | OP_1SUB OP_2 | |
| | | | OP_FROMALTSTACK | | OP_DIV | |
| | <0x00> | <0x010101> | OP_2 OP_MOD | <0x00010101> | | |
| | | | OP_ELSE | | | |
| | | | <0x00> | | | |
| | | | OP_FROMALTSTACK | | | |
| | | | OP_CAT | | | |

The function converts the hexadecimal <0x07> to its binary representation <0x00010101> where each byte represents one bit. Note that the 0x prefix denotes that the bytes following it are a hexadecimal number, and so <0x00010101> isn't actually equivalent to 0x07 in binary, but the way that the next opcodes read this representation will treat it as such. If it is read exactly as it is written, <0x00010101> is equivalent to the decimal 65793. The state of the stack after execution of the function [Hex to binary] is the following:

$$\text{} \begin{matrix}〈 \begin{matrix}Binary representation of {UHF}_{a , b , p , {2}^{512} - Left} \\ ( {c}_{parent} ‖ {P}_{parent} ‖ index )\end{matrix} 〉 \\ 〈 {P}_{parent} ( x ) 〉 \\ 〈 {P}_{parent} ( y ) 〉\end{matrix} \text{}$$

The function [Hex to binary] results in a string where each byte now represents one bit. For this particular example PKD script, the string must be split into an array using the following opcodes:

$${[ OP\_ 1 OP\_SPLIT OP\_SWAP ]}^{256}$$

where the square brackets to a power indicate the number of times this should be repeated, which in this case is 256 times. This results in a binary array of length 256 where the byte representing the least significant bit is at the top of the stack. Each byte in the array represents one bit and is either <0x01> or <0x00>. The above described process involves concatenating the binary representation in the conversion to binary and then splitting the result into an array. The reason for this split is that the result is required to be in little endian format. This result may be achieved without concatenation, but it would require keeping track of the depth of the stack and then to keep bringing stack items to the top, whilst keeping the order. It is much simpler to concatenate the result into one string, utilise the altstack, and split it afterwards, as achieved by the scripts above.

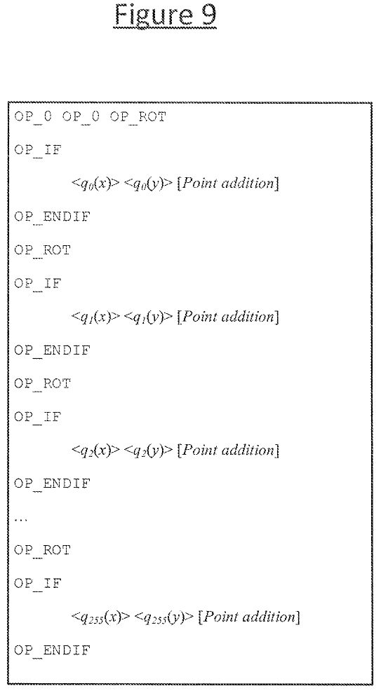

The following illustrates an example of how to perform the point scalar multiplication in Script. The [Point scalar multiplication] function (i.e. the PSM script). The [Point scalar multiplication] function takes the HMAC function result (in some examples, only the left 32 bytes of the HMAC function result) as a binary representation and returns UHF_{a,b,p,2}_{⁵¹²}_{-Left}(cₚₐᵣₑₙₜ∥Pₚₐᵣₑₙₜ∥index). For simplicity of notation, the following definition is used: q:=UHF_{a,b,p,2}_{⁵¹²}_{-Left}(cₚₐᵣₑₙₜ∥Pₚₐᵣₑₙₜ∥index). Then the corresponding point q·G can be calculated. To calculate q·G in script, first pre-calculate q₀=2⁰·G, q₁=2¹·G, . . . , q₂₅₅=2²⁵⁵. G. This allows for the calculation of any possible q·G for 0≤q<2²⁵⁶. This is because, taking a binary representation as input, if the ith digit of the binary representation is 1, the corresponding 2ⁱ will be added to the current state of the calculation of q·G. If the ith digit is 0, the corresponding 2ⁱ will not be added to the current state of the calculation of q·G. An example PSM script for achieving this is illustrated in FIG. 9. Assuming an input q in the form of a little-endian binary array, the examples script in FIG. 9 calculates q·G, where <qᵢ(x)> represents the x-coordinate of 2ⁱ·G and <qᵢ(y)> represents the y-coordinate of 2ⁱ·G.

This function adds the point 2ⁱ·G to the current state of q·G when the corresponding bit of q is equal to 1. This function uses [Point addition] (i.e. the point addition script), which is described below. The [Point scalar multiplication] function begins by pushing <0x00><0x00>to the stack, the purpose of which is to act as an initial point, which in this case is the identity element. Since the [Point addition] takes two points as input, without pushing <0x00><0x00> to the stack initially, the first execution of this will only have one input and will result in an error. In essence, <0x00><0x00> acts as the identity element, since [Point addition] is defined in a way that if one point is <0x00><0x00>, then the function simply outputs the other point. Note that the reason it is safe to choose this notation as the identity is because the point (0,0) is not a point on the secp256k1 elliptic curve. The state of the stack at this point is now the following:

$$\text{} \begin{matrix}〈 ( q \cdot G ) ( x ) 〉 \\ 〈 ( q \cdot G ) ( y ) 〉 \\ 〈 {P}_{parent} ( x ) 〉 \\ 〈 {P}_{parent} ( y ) 〉\end{matrix} \text{}$$

where the top two items are the x- and y-coordinates of the result of the calculation of q·G.

The [Point addition] function is the final function used in the child key derivation. It takes the result of [Point scalar multiplication] and the Pₚₐᵣₑₙₜ key, which has been stored at the bottom of the stack since it was duplicated in the first few opcodes of the function [P_{child} derivation], and returns P_{child} to the stack. There are a few functions that need to be calculated before defining the full function. These are:
[Inverse mod p]
[Different Point addition]
[Same Point addition]

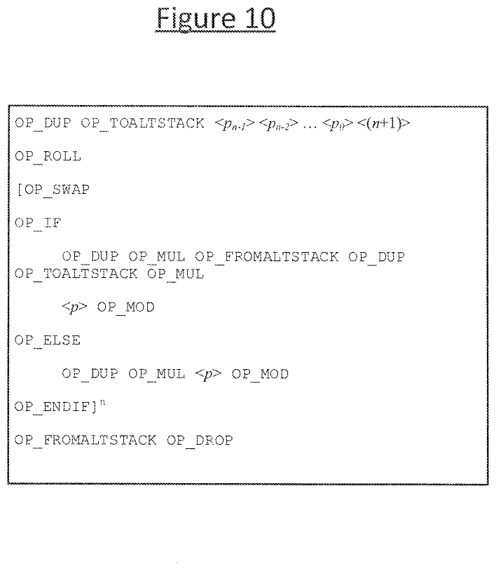

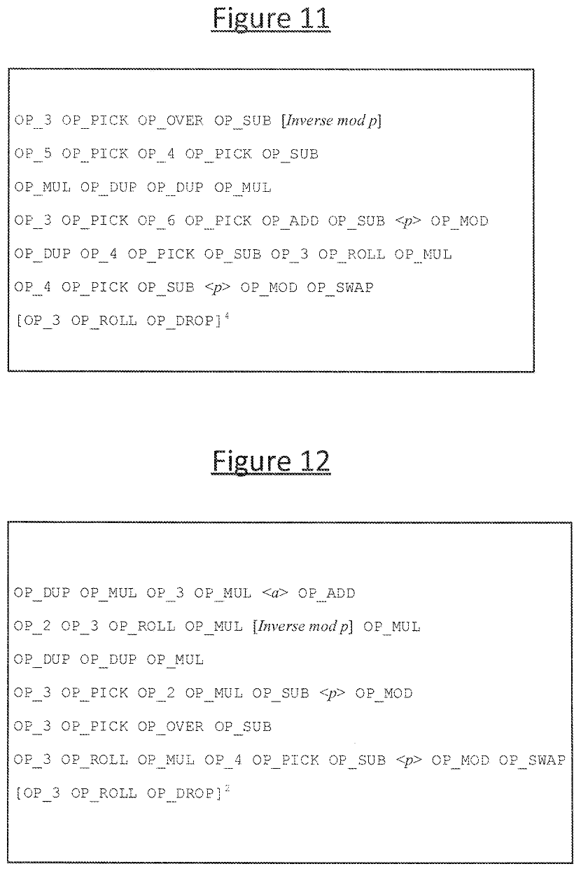

First, an example of an inverse modulo p in script is described, which will be used in the addition of two points. Fermat's little theorem states that m⁻¹=m^{p-2} mod p. Note that p here is not the same as the fourth parameter of the HF script. Assuming that the input p is known, then the code shown in FIG. 11 can be used to find the inverse of m modulo p, that is, to calculate m^{p-2} mod p. <pₙ₋₁><pₙ₋₂> . . . <p₀> represents an array, where each item of the array corresponds to the binary index of (p−2), that is, p′=p−2=p₀2⁰+p₁2¹+ . . . +pₙ₋₁2ⁿ⁻¹, where the opcodes in FIG. 10 calculate the function [Inverse mod p] given the input <m>.

In this example, n is 256, which is the binary length of p. The opcode <(n+1)> combined with OP_ROLL brings <m> to the top of the stack after the binary array of p−2 is pushed onto the stack. p−2 is pushed to the stack at this point to ensure this inverse function is self-contained and so can easily be applied in other cases. Again, the notation of the square brackets to the power indicate the number of times this code is repeated.

FIG. 11 illustrates an example script for performing a point addition. In this case, the example script performs a point addition of two different points. When adding two different points, the input is <y₂><x₂><y₁><x₁>, where each coordinate is a 32-byte hexadecimal. Then the code in FIG. 12 calculates the function [Different Point addition], returning <y₃><x₃> to the stack. The following illustrates the state of the stack at the end of every line in the code of FIG. 11. The state of the stack begins with the input, and then each row of the example code is executed in turn.

| | | | | | |
|---|---|---|---|---|---|
| <x₁> | OP_3 OP_PICK | <(x₂ − x₁)⁻¹> | OP_5 | <y₂ − y₁> | OP_MUL |
| <y₁> | OP_OVER | <x₁> | OP_PICK | <(x₂ − x₁)⁻¹> | OP_DUP |
| <x₂> | OP_SUB | <y₁> | OP_4 | <x₁> | OP_DUP |
| <y₂> | [Inverse mod p] | <x₂> | OP_PICK | <y₁> | OP_MUL |
| | | <y₂> | OP_SUB | <x₂> | |
| | | | | <y₂> | |

| <(y₂ − y₁)>²(x₂ − x₁)⁻²> | OP_3 | <x₃> | | OP_DUP |
|---|---|---|---|---|
| <(y₂ − y₁)>(x₂ − x₁)⁻¹> | OP_PICK | <(y₂ − y₁)>(x₂ − x₁)⁻¹> | | OP_4 |
| <x₁> | OP_6 | <x₁> | | OP_PICK |
| <y₁> | OP_PICK | <y₁> | | OP_SUB |
| <x₂> | OP_ADD | <x₂> | | OP_3 |
| <y₂> | OP_SUB | <y₂> | | OP_ROLL |
| | <p> | | | OP_MUL |
| | OP_MOD | | | |
| <(y₂ − y₁)>(x₂ − x₁)⁻¹> | OP_4 OP_PICK | <x₃> | [OP_3 | <x₃> |
| (x₁ − x₃)> | OP_SUB | <y₃> | OP_ROLL | <y₃> |
| <x₃> | <p> | <x₁> | OP_DROP] ⁴ | |
| <x₁> | OP_MOD | <y₁> | | |
| <y₁> | OP_SWAP | <x₂> | | |
| <x₂> | | <y₂> | | |
| <y₂> | | | | |

This completes the calculation of adding different points in script.

FIG. 12 illustrates another example script for performing a point addition. In this case, the example script performs a point addition of the same point. When adding two same points, the input is <y₁><x₁><y₁><x₁>, where each coordinate is a 32-byte hexadecimal. Then the code in FIG. 12 calculates the function [Same Point addition], returning <y₂><x₂> to the stack. The following illustrates the state of the stack at the end of every line in the code of FIG. 12. The state of the stack begins with the input, and then each row of the example code is executed in turn. Note that a (not the same as the first parameter of the HF script) is a constant that is defined by the elliptic curve, which in this example is secp256k1, and so a=7.

| | | | | | |
|---|---|---|---|---|---|
| <x₁> | OP_DUP | <3x₁² + a> | OP_2 OP_3 | <(3x₁² + a)(2y₁)⁻¹> | OP_DUP |
| <y₁> | OP_MUL | <y₁> | OP_ROLL | <x₁> | OP_DUP |
| <x₁> | OP_3 | <x₁> | OP_MUL | <y₁> | OP_MUL |
| <y₁> | OP_MUL | <y₁> | [Inverse mod p] | | |
| | <a> | | OP_MUL | | |
| | OP_ADD | | | | |

| <(3x₁² + a)(2y₁)⁻²> | OP_3 OP_PICK OP_2 | | <x₂> | OP_3 |
|---|---|---|---|---|
| <(3x₁² + a)(2y₁)⁻¹> | OP_MUL OP_SUB <p> | | <(3x₁² + a)(2y₁)⁻¹> | OP_PICK |
| <x₁> | OP_MUL | | <x₁> | OP_OVER |
| <y₁> | | | <y₁> | OP_SUB |
| <x₁ − x₂> | OP_3 OP_ROLL | <x₂> | [OP_3 OP_ROLL | <x₂> |
| <x₂> | OP_MUL OP_4 | <y₂> | OP_DROP] ² | <y₂> |
| <(3x₁² + a)(2y₁)⁻¹> | OP_PICK OP_SUB | <x₁> | | |
| <x₁> | <p> OP_MOD | <y₁> | | |
| <y₁> | OP_SWAP | | | |

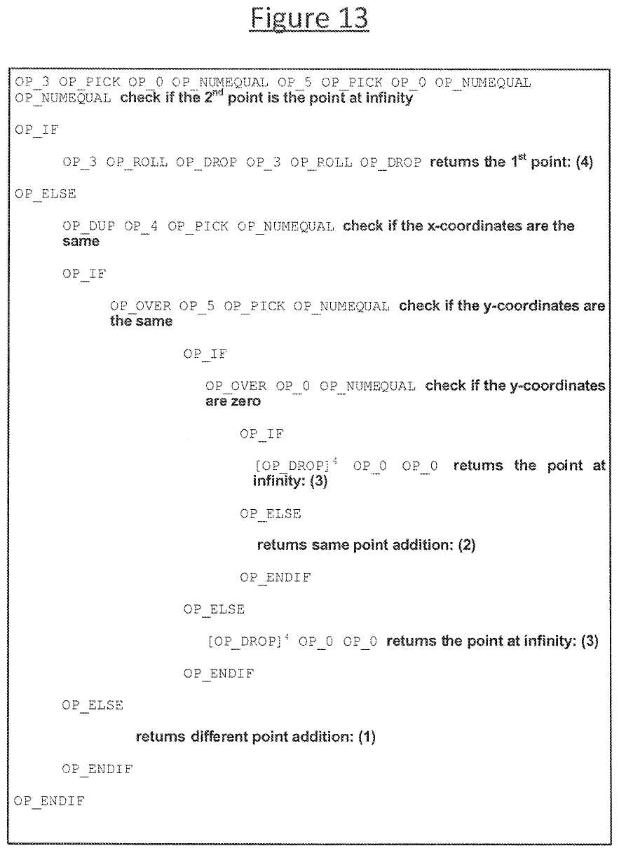

FIG. 13 illustrates another example script for performing a point addition. In this case, the example script performs a check of whether the two points to be added are the same point or different points, and the acts accordingly. Note that the bold text in FIG. 13 explain what that line of code is doing, and the numbers (i) correspond to the definition of point addition given above. The input is assumed to be in the form <y₂><x₂><y₁><x₁>, where each coordinate is a 32-byte hexadecimal.

The first line is a check for the second point being <0x00><0x00>, which in the chosen notation is the point at infinity, since it is known that this point is not on the secp256k1 curve. If the second point is the point at infinity, then the first point <y₁><x₁> is returned to the stack, which corresponds to definition (4) of point addition. Note that in the example code, the point at infinity only ever appears as the second point.

Then the first line inside the first OP_ELSE checks if the x-coordinates are equivalent. If they are, a check of whether the y-coordinates are also equivalent is performed. If it finds that they are, then a check of whether y=0 is performed, in which case the point at infinity is returned, which corresponds to definition (3) of point addition. If y≠0, then the code adds a point to itself, which is the function [Same Point addition] defined above, and corresponds to definition (2) of point addition definition. Next, if the y values are different, then the points must be inverse to each other, returning the point at infinity, so <0x00><0x00> is returned. This corresponds to definition (3) of point addition. Finally, if the x values are different, the code executes different point addition [Different Point addition], corresponding to definition (1) of point addition.

This completes the calculation of point addition in script, and ultimately completes the calculation of child keys in script. The final state of the stack is now the following:

$$\text{} \begin{matrix}〈 {P}_{child} ( x ) 〉 \\ 〈 {P}_{child} ( y ) 〉 \\ \end{matrix} \text{}$$

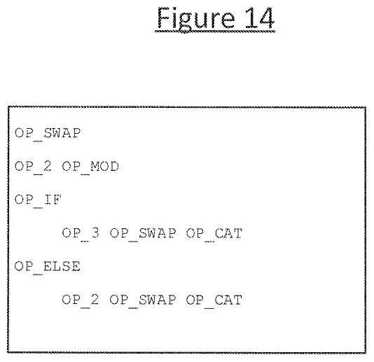

FIG. 14 illustrates an example script for converting the data on the stack into a compressed key format. The example function takes the x and y coordinate of a key as inputs, and returns the compressed public key format. For an input <P(y)><P(x)>, the opcodes in FIG. 14 defines the function [Compressed Key format]. The first 3 opcodes check if the y coordinate of the child key is even or odd. Then the next opcodes append the x-coordinate with the correct prefix depending on this result. This results in the compressed child key, giving the final state of the stack to be the following:

$$\text{} \begin{matrix}〈 {P}_{child} 〉 \\ \\ \end{matrix} \text{}$$

Alternatively, if in fact the result is desired to be in uncompressed format, the following function may be used:

$$[ Uncompressed Key format ] = OP\_SWAP OP\_CAT 〈 0 x 04 〉 OP\_SWAP OP\_CAT .$$

In some embodiments, the HF script may be used to generate keys in key-value pairs, which can be used for a look-up table. Many applications, including wallets, require efficient look-up operations to identify spent, unspent, or application-related public keys. One efficient way to construct a look-up table is to use universal hash functions to create keys in key-value pairs. The in-script universal hashing approach described above effectively puts a copy of the keys in the key-value pairs on chain. This allows a seamless integration to a local look-up table as they share the same keys (hash values). For applications with smaller volume of public keys, they can reduce the number of bytes of the universal hash outputs by trimming the hash values while keeping the full value on chain.

For example, Alice 103a may store the expected hash result, or a shortened version of the expected hash result (e.g. the first four leading bytes), in a look-up table together with (i.e. mapped to a corresponding expected public key and/or a transaction identifier of the first transaction. In other words, the (shortened) expected hash result is the key of a key-value pair, where the value is the expected public key and/or transaction identifier. The look-up table may comprise several key-value pairs of this type, for different hash results, public keys and transaction identifiers. Alice 103a may use the (shortened) expected hash value as a look-up to find the corresponding public key and/or transaction identifier.

The examples described so far have only considered generating a single expected hash result for a given public key. That is, the examples have only described generating <UHF_{a,b,p,n}(PK)> where <UHF_{a,b,p,n}(PK)> is the expected hash result generated by applying the universal hash function (UHF) to an expected public key, PK. This is used to lock an output of a transaction to the public key, such that the public key and (optionally) a corresponding signature is required to unlock the output. The following will describe how to use the UHF to derive multiple expected hash results for a given public key. These expected hash results will be referred to as blockchain addresses.

As discussed above, the UHF is dependent on four parameters, a, b, n and q. The examples above describe how a single address (expected hash result) can be generated from a public key by applying the UHF to the public key with a fixed set of parameters. Now, by changing the values of the parameters, multiple addresses may be derived from the same public key. That is, the value of the parameters a, b, n and q may be changed in order to generate different addresses. In some examples, only a single parameter is changed. In other examples, more than the value of more than one parameter is changed. For instance, the values of all of the parameters may be changed.

An address may be generated for every possible value of the parameter a. Similarly, an address may be generated for every possible value of the parameter b. In some examples, an address may be generated for every possible combination of a and b. In these examples, the values of the parameters n and q may be fixed. Alternatively, the values of the parameters n and q may be varied.

The parameters may take any suitable value, including any value discussed above.

The different addresses may be used to lock different transaction outputs. For example, one or more outputs of the same transaction may be locked using a different one of the addresses derived from the same public key. Additionally or alternatively, one or more outputs of one or more different transactions may be locked using a different one of the addresses derived from the same public key.

The locking script that locks the outputs takes the same form as described above. For examples, the locking script may take the following form:

$$OP\_DUP [ {UHF}_{a , b , p , n} ] 〈 {UHF}_{a , b , p , n} ( PK ) 〉 OP\_EQUALVERIFY OP\_CHECKSIG$$

Where [UHF_{a,b,p,n}] is shorthand for:

$$〈 a 〉 OP\_MUL 〈 b 〉 OP\_ADD 〈 p 〉 OP\_MOD 〈 n 〉 OP\_MOD .$$

The values of a, b, n and q are defined in the locking script and correspond to the values used to generate the corresponding address. That is, the values of the parameters that are used to generate an address are the same values that appear in the locking script that comprises that same address.

The corresponding unlocking script takes the following form:
<Signature> <PK>

One can see that the form of the unlocking script stays the same for each address. That is, although the address changes depending on the parameters used to derive the address, the locking script is still unlocked using the public key from which the address is derived, and a signature corresponding to the public key (i.e. generated using a private key corresponding to the public key).

Referring back to FIG. 5, Alice 103a may generate a plurality of addresses using Bob's same public key. Each address is generated by hashing the public key using the universal hash function, wherein the value of at least one parameter of the UHF is changed for each different address. The first transaction that is generated by Alice 103a and submitted to the network 106 may include multiple outputs, each of which comprises an instance of a locking script which locks the output to one of the addresses. That is, the locking script includes the address and requires an unlocking script to include a public key which will be hashed by the HF script to give the address. Additionally or alternatively, Alice 103a may generate one or more additional transactions. Each transaction includes at least one output locked to one of the addresses derived from Bob's public key.

In some examples, the addresses may be generated by hashing the result of the universal hash function with a cryptographic hash function. That is, Alice 103a may derive a plurality of addresses using the universal hash function (again, changing the value of one or more parameters of the UHF to generate each different address), and then hash each of those addresses using the cryptographic hash function. For convenience, the addresses output by the UHF will now be referred to as “intermediate addresses”, or “intermediate hash results”. So, Alice 103a generates a plurality of different intermediate addresses and hashes each intermediate address to generate a corresponding final address. In these examples it is the final address that is used as the blockchain address, i.e. the address that appears in the output of the blockchain transaction.

In these examples, each locking script is configured to generate the intermediate address and then hash the intermediate address to generate the final address. The final address is compared with an expected final address that is included in the locking script. Depending on the form of the locking script, the parameters of the UHF may be included in the unlocking script rather than the locking script. An example is given below.

The cryptographic hash function may be any suitable hash function. For example, the cryptographic hash function may be RIPEMD160, SHA256, SHA512, etc. In some examples, the cryptographic hash function may be a combination of more than one hash function. For instance, the cryptographic hash function may be HASH160 which comprises hashing first with SHA256 and then with RIPEMD160.

As discussed above for the case of generating single address, Alice 103a may store the plurality of different addresses (intermediate and/or final) in a look-up table for ease of reference. The addresses may be associated with an index or with the public key from which the addresses are derived.

### 8. Index Hash

This section provides further examples of the described embodiments.

### 8.1 Cryptographic Hash

Cryptographic hash functions are one-way functions that produce an unpredictable and fixed length output from an arbitrary sized input. They are used frequently in Bitcoin transaction scripts to hide the pre-image input. One of the most common examples of this is to mask the public key in a P2PKH transaction. As highlighted, P2PKH transactions are larger than P2PK transactions and are therefore more costly to transact overall. P2PKH typically involves the following locking script:
OP_DUP OP_HASH160 <HASH160(PK)> OP_EQUALVERIFY OP_CHECKSIG.

In this setup the person locking the funds must know the hashed value of the public key, referred to as the address, of the receiving party. The sending party will lock funds to this hash value. This has the effect of masking the public key. HASH160 is the algorithm used on chain to perform this and is composed of 8 steps:
1. SHA256( );
2. RIPEMD160( );
3. adding prefix to the output for network type;
4. SHA256( );
5. SHA256( );
6. taking the first 8 bytes of the output of Step 5;
7. adding this to the output of Step 3; and
8. base58-encoding.

The output of HASH160 is unpredictable and deterministic, e.g. the same input will always produce the same output.

Public keys are typically not linked to an individual's identity and therefore masking is not necessary to maintain the privacy of an individual. However, it is possible for attackers to link commonalities between multiple transactions. For example, if an attacker Bob knew real world information about Alice it might be possible for Bob to link a public key to Alice. This would not compromise the security of Alice's funds in any way but could allow Bob to track Alice's transactions related to this public key and therefore reduce her privacy. The HASH160 algorithm provides a mask for a public key in a P2PKH transaction script locked in the above manner, it is computationally infeasible for a party to derive the public key from the hashed value available on chain. However, as the algorithm is deterministic, the same public key will always produce the same hashed value. This would therefore allow an attacker to simply match the same on-chain P2PKH hashed values together if used more than once.

Further, to unlock funds the receiving party must still provide their pre-image public key on-chain. Once accepted, the network can associate this public key with the P2PKH hash value and could connect any other on-chain P2PKH transaction associated with that public key. It is therefore strongly recommended that to increase privacy a party should always vary their public key for new transactions. This brings into question what functionality masking in this way provides, especially considering the additional cost incurred in utilising P2PKH over P2PK. If the public key should be altered for every transaction, it would be infeasible to link accounts to public keys, thus mitigating the need to mask them. Further, the security of ECDSA is currently considered computationally infeasible to break, so the additional layer of security provided by hashing seems unnecessary.

### 8.2 Universal Hash

As discussed above, universal hashing refers to a form of hashing that typically takes the form:

$${Hash}_{UHF} ( x ) = ( ( ax + b ) mod p ) mod n$$

Where x is the input and a, b, p and n are predetermined and random integers that are typically kept secret. Universal Hash Functions (UHF) have two main properties:

$$1. Deterministic - {Hash}_{UHF} ( x ) = {Hash}_{UHF} ( y ) when x = y ,$$

$$2. Uniform mapping distribution - Pr \{ {Hash}_{UHF} ( x ) = {Hash}_{UHF} ( y ) \} \leq \frac{1}{q}$$

$$for two randomly chosen inputs x , y .$$

This second condition defines that UHF evenly distribute outputs, so that the probability of two distinct inputs hashing to the same value is less than or equal to 1 over the output size n.

As shown, UHF utilises only one multiplication, one addition and two modular operations. It is therefore extremely efficient to perform this style of hashing many times to create an index of outputs. It is much more efficient than HASH160 which, as shown above, utilises more steps with each of these more complicated.

Further, compared to cryptographic hash functions, UHFs allow a degree of choice for the parameters used from the party computing them. This flexibility can be used to provide functionality currently not available in HASH160.

### 8.3 Index Hash

Public key hashing in P2PKH transactions ensures that the public keys are not disclosed to other users prior to that public key's owner spending funds. This creates an additional layer of security between the user's private key and the public network, providing a degree of increased privacy. However, as deriving a private key from the public key is currently considered computationally infeasible, this may be considered unnecessary. Further, as HASH160 is deterministic, an attacker can easily connect the same hashed values of public keys together and link them to a public key once funds are unlocked by the user. As a result, users are recommended to alter their public key for each transaction to increase privacy. Thus, masking using HASH160 in a P2PKH transaction vs a P2PK transaction seems limited to reducing the size of a locking script by 13 bytes but increasing the unlocking script by 33 bytes.

UHF's allow a level of control over parameters that generates much more functionality than the cryptographic hash functions currently used in script. The present disclosure describes how this functionality may be used to produce multiple hashed addresses from a single public key, link multiple public keys to a common hashed address and be used in conjunction with a cryptographic hash to provide multiple secure addresses from a single address. UHF's are extremely efficient due to the simple arithmetic they utilise.

### 8.4 Universal Hash Function

An example Universal Hash Function (UFH) that generates the hashed address Aᵢ is defined herein as:

$${A}_{i} = {Hash}_{UHF} ( {P}_{i} ) = [ {aP}_{i} + b mod n ] mod n$$

Where Pᵢ represents the compressed version of public key for the ith user, which is the integer value for the x-coordinate with a positive or negative indicator for the 2 possible corresponding y values. We assume that xᵢ∈[0, p−1], and we use −xᵢ as the input to the universal hash function for (xᵢ, −).

HASH 160 always produces the same output address for the same public key. An attacker can simply associate the same hashed public key values together if the private-public key pair is reused. Once the unlocking public key is revealed during a transaction the attacker can link all those hashed value to the public key and the mask is redundant. It is therefore recommended that users create a new public key for each transaction. This can be laboursome and requires each new public key to be transmitted to the funding party for each new transaction.

Using the multiplicative hash function, one may generate indexed addresses from a single public key. Where a and b are randomly generated for each new address created (p and n may also be changed, depending on use case). This can be efficiently recorded in a look up table stored offline. Public keys may be associated with an index and corresponding addresses can be searched using the index or public key.

$${Hash}_{UHF} ( {P}_{i} ) = [ {aP}_{i} + b mod p ] mod n .$$

| Index | aᵢ, bᵢ | A = Hash_{UHF} (P) |
|---|---|---|
| 1 | a₁, b₁ | A₁ |
| 2 | a₂, b₂ | A₂ |
| 3 | a₃, b₃ | A₃ |
| . | . | . |
| . | . | . |
| . | . | . |

The above table could be used to generate a maximum n number of different masked addresses for a single public key, where aᵢ, bᵢ are selected randomly. This would allow a funding party, with knowledge of a single public key for a receiving party, to generate many transactions to that party without having duplicate locking script addresses. Further, the receiving party would not need to have knowledge of this process and would only need to input their public key and signature. This is a more efficient solution than the recipient having to generate a new public key for each transaction and send this to the funding party.

Although unlikely, it may be prudent to check for collisions for separate aᵢ, bᵢ producing the same address, modulo n. As will be discussed, the security of this mask system is related to value n. It is therefore likely that these would be selected for the desired level of security and fixed for the addressing scheme.

The probability of two randomly chosen public keys, Pᵢ and Pⱼ, collide to the same hashed address (e.g UHF_{a,b,p,n}(Pᵢ)=UHF_{a,b,p,n}(Pⱼ)) is bounded by:
12/n

Where p is set to the same value as in the input space to the UHF, which in this case is the p prime that comes with Secp256k1.

### 8.5 Parameter Selection

Pᵢ—this compressed public key value is considered random as the payee cannot select which public keys they wish to send funds to.
p—we may choose p to be the prime that comes with Secp256k1, the elliptic curve used in Bitcoin addressing. We may use this value as it maximises collision resistance for the first modulo. Any larger number would not be beneficial as it we would effectively be spreading a smaller input size (p) over a large output size. It has a fixed value of 2²⁵⁶−2³²−2⁹−2⁸−2⁷−2⁶−2⁴−1. Other values of p may be chosen.
n—is selected to increase or decrease the collision probability. A smaller n value decreases the output size, leading to a higher number of collisions. Where all security is derived from bitcoins ECC key pair security, a larger n is considered more ‘secure’, as there would be fewer number of collisions, so there would be less unintended public keys that would resolve to the address to access the funds. We can also alter this n value to change the fixed length output size, e.g. set maximum n=2¹⁶⁰ so it has same fixed length output as Hash160, for example. One may typically fix n depending on the requirement.
a, b—The value a and the value b may be chosen randomly from [symbol] ₚ by the user. However, a cannot equal zero, a∈_{R} [symbol] ₚ\{0}. We may select a, b from the range p such that: 1≤a≤p−1 and 0≤b≤p−1. This would provide the greatest amount of choice and variability for the hashing scheme. The range and size of a or b does not affect the collision probability.

### 8.6 Script

The following highlights how the transactions may be locked and unlocked:
Locking Script: OP_DUP<a>OP_MUL<b>OP_ADD<p>OP_MOD<q>OP_MOD<Aᵢ>OP_EQUALVERIFY OP_CHECKSIGVERIFY
Unlocking Script: <Sigᵢ><Pᵢ>

Where Pᵢ represents the compressed form of the public address.

### 8.7 Transaction Size

The above locking script contains 7 opcodes (OP_MUL, OP_ADD, OP_MOD, OP_MOD, OP_EQUAL and OP_CHECKSIGVERIFY), which are each 1 byte in size. The hashed address Aᵢ would require a maximum 32 bytes on script, but this value is based on variable modulo n as discussed.

The locking script size depends mostly on the sizes of the four input parameters sizes a, b, p and n). As mentioned these can be determined by the users. The p value may be a maximum 32 bytes (as this is the maximum input space taken from the modulo 2²⁵⁶ from Secp256k1). From here a, b and n sizes can be selected dependent on requirement.

| | Locking Script | Unlocking Script | Overall Size |
|---|---|---|---|
| | Size(bytes) | Size (bytes) | (bytes) |
| P2PK | 35 | 74 | 109 |
| P2PKH | 25 | 108 | 133 |
| UHF (a = 2⁸⁰ b = | 121 | 109 | 230 |
| 2³², n = 2²⁵⁶) | | | |

As shown, transactions using the UHF transaction are larger than standard P2PK and P2PKH. For the above UHF locking script a, b, p and n values represent 80 bytes out of the total 121. We could considerably decrease the transaction size by selecting smaller parameters when appropriate. This would have security and variability implications as will be discussed in the next section.

Another method for reducing in script parameter size would be to represent values by directly pushing bits. For example, if n was selected as the value 2²⁵⁶ exactly, rather than some value within that range, we could represent 2²⁵⁶ as 16⁶⁴. Using this we could simply push the value 16⁶⁴ (which in hex is 1 followed by 64 0's) in script using the following op codes:

$$OP\_ 1 〈 64 〉 OP\_LSHIFT$$

Doing this would only use 4 bytes of memory, instead of 32 bytes that would be required to represent any number within the range 0-2²⁵⁶. However, such methods would only be more efficient if exact powers of 16 are used for the parameters. For example, as we say our modulo p is fixed to 2²⁵⁶-2³²-977 (from Secp256k1). We can represent this more efficiently using the above method like so:

$$OP\_ 1 〈 64 〉 OP\_LSHIFT OP\_ 1 OP\_ 8 OP\_LSHIFT OP\_SUB 〈 977 〉 OP\_SUB$$

The above does the following:
1. Push 1 and left-shift this 64 places, forming the value 2²⁵⁶,
2. Push 1 and left-shift this 8 places, forming the value 2³²,
3. Subtract 2³² from 2²⁵⁶,
4. Push the value 977 and subtract this from the previous output.

This method forms the p value Secp256k1 in 12 bytes, rather than 32 bytes.

### 8.8 Security

The UHF enables multiple distinct public keys to hash to the same unlocking address. This provides masking to the public keys prior to their being unlocked. Firstly, the hashed on-chain address is distinct from the public key for which it is intended. Secondly, if the attacker wished to do work to derive which public keys could unlock the scripts, they would need to calculate all possible public keys that could collide to that address.

For example, consider that we select a modulo n value that resulted in 1 billion possible public key collisions for our single on-chain hashed address. This would mean that an attacker would need to derive 1 billion public keys that could solve for the on-chain locking script. This would require that the attacker solve for the UHF and then derive all values that collide for this modulo n, from input space p. So the attacker could derive and store all p/n number of values, but it would not greatly assist the attacker in identifying/tracking the activity of a single user's public key address. When considering that the attacker would have to keep track of many UHF locking scripts in this way, we can describe the UHF as a masking function at the expense of some security.

As stated, the security of the UHF is derived from ECC key pair security. It is computationally infeasible to work out the private key that corresponds to a public key that can unlock the script address. Even if in the case where there are 1 billion public keys that could solve to form the same address in our locking script, this would still give the attacker an approximately

$$\frac{{2}^{32}}{{2}^{256}}$$

chance of deriving a private key that forms the public key per attempt.

### 8.9 Hybrid Hash

As described, the UHF provides additional functionality unavailable from cryptographic hashing. However, it would be somewhat trivial to derive potential public keys, Pᵢ, that could solve for the on-chain UHF:

$${A}_{i} = [ {aP}_{i} + b mod p ] mod n$$

Provided a, b, p, n and Aᵢ which would all be visible on chain.

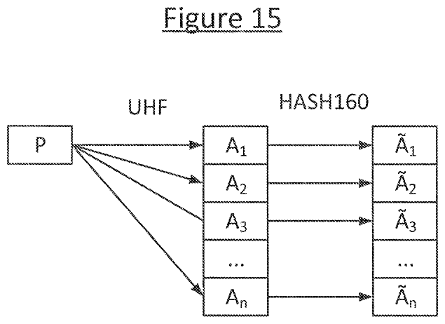

This vulnerability can be dealt with by passing the UHF output Aᵢ, through a cryptographic hash function, such as HASH160. This would combine the pre-image resistance of cryptographic hashing with the flexibility of UHF's. We will refer to this as hybrid hashing as it involves both forms of hash function. This is illustrated schematically in FIG. 15.

The pre-image resistance provided by HASH160, would make it computationally infeasible to derive Aᵢ from the publicly visible address hash Ãᵢ, which in turn makes it infeasible to compute potential public keys, Pᵢ, that solve for Ãᵢ. Although requiring more operations, this hybrid hashing would provide all the functionality described above. Parties may create a hash index table that efficiently outputs multiple addresses from a single public key, by varying UHF parameters. These distinct address values, when passed through HASH160, would also have very distinct values Ãᵢ. However, now it would be infeasible to compute the pre-image value Aᵢ from Ãᵢ, and therefore infeasible to compute the public key(s) that solve for this address. The hash index table may take the following form:

| Index | aᵢ, bᵢ | Aᵢ = Hash_{UHF} (P) | Ãₗ = HASH160(Aᵢ) |
|---|---|---|---|
| 1 | a₁, b₁ | A₁ | [symbol] |
| 2 | a₂, b₂ | A₂ | [symbol] |
| 3 | a₃, b₃ | A₃ | [symbol] |
| . | . | . | . |
| . | . | . | . |
| . | . | . | . |

### Where,

$$\neq \neq {\tilde{A}}_{ι}$$

The locking and unlocking script may take the following forms:
Locking Script: OP_DUP OP_TOALTSTACK OP_MUL OP_ADD OP_MOD OP_MOD OP_HASH160 <Ãᵢ>OP_EQUALVERIFY OP_FROMALTSTACK OP_CHECKSIG
Unlocking Script: <Sigᵢ><n><p><bᵢ><aᵢ><Pᵢ>

Using pre-image resistance in hybrid hashing we may now choose to offset all UHF parameters to the unlocking script, to make the locking script more compact. This has the benefit of significantly reducing UTXO storage space, but also necessitates the unlocking party knows the hash index table. Further, the UHF values a, b, p and n may be enforced by concatenate them into the address and verifying this value.

The functionality of the UHF (indexed hashing) is now enhanced as it is computationally infeasible to compute public keys that could solve for the UHF on chain. Further, the locking script size is significantly smaller than those in multi-signature transactions, reducing the UTXO memory size used by nodes. As shown, it includes both cryptographic and universal hashing to best obscure the addresses.

| | Locking Script | Unlocking Script | Overall Size |
|---|---|---|---|
| | Size(bytes) | Size (bytes) | (bytes) |
| P2PKH | 25 | 108 | 133 |
| Hybrid Hash | 31 | 188 | 219 |
| (a = 2⁸⁰ b = | | | |
| 2⁸, q = 2²⁵⁶) | | | |

### 9. Example Use Case

### 9.1 Single User

This section describes an example use case for the described embodiments. Alice 103a runs an online game. Bob 103b is a regular player of Alice's game. Alice 103a regularly generates transactions to Bob 103b for his winnings. Bob 103b is lazy and uses a cold storage wallet, making it inconvenient to constantly generate new private-public key pairs each time he plays the game. To reduce communication costs, Bob 103b requests that Alice 103 use the same public key in all payment transactions to him. Bob 103b would like to ensure that the UTXOs assigned to him in these separate transactions cannot be linked by an external party until they have been spent. Alice 103a therefore uses the described index hash system for transmitting the regular payments to Bob 103b.

Bob 103b will generate a one-time-only public key P for Alice 103a. Alice 103a will then create a secure, off-chain lookup table for this single public key. Generating n number of maximum addresses Ãᵢ, in the following way:

| | | Aᵢ = [aᵢP + bᵢ | |
|---|---|---|---|
| Index | aᵢ, bᵢ | mod p] mod n | [symbol] = HASH160(Aᵢ) |
| 1 | a₁, b₁ | A₁ | [symbol] |
| 2 | a₂, b₂ | A₂ | [symbol] |
| 3 | a₃, b₃ | A₃ | [symbol] |
| . | . | . | . |
| . | . | . | . |
| . | . | . | . |
| q | a_{q}, b_{q} | A_{q} | [symbol] |

Alice 103a can now use these indexed hybrid hashes to generate a maximum n number of distinct addresses Ãᵢ. Alice 103a and Bob 103b can be secure in the knowledge that each of these transactions will have a different on-chain address, making it difficult for a bad actor to associate them together. Further, the cryptographic hash function ensures that this same bad actor cannot calculate the public key P used to derive these.

Bob 103b simply needs to use the same public key and relevant digital signature to unlock all these transactions, making the process far simpler on his part than constantly updating and transmitting his public key.

### 9.2 Open Puzzle Competition

Similarly, to the above example, Alice 103a wishes to outsource the verification of some publicly available records. However, now she does not want to tie them to any specific public keys and simply wishes for anyone who can verify the records to be able to unlock the associated funds. This can be achieved through setting a sufficiently small n in the linked address scheme from:

$${A}_{i} = [ {aP}_{i} + b mod p ] mod n$$

For example, if q=2 then half of all public keys and corresponding signatures could unlock the script. This would not be ideal as it would be extremely trivial for a Bitcoin node to simply replace the transaction solution with their own public key and signature to claim the funds that they did not work to do.

However, Alice could set the q value to be sufficiently high such that an unknown solving party could generate a private-public key pair that satisfied the address system off-line, on average, over the course of days for example. This would ensure that it would not be feasible for a rogue Bitcoin node to generate their own satisfactory private-public key pair in the average mining time for a block (10 minutes). Assuming that there are at least some good miners, the original transaction would be validated and published into the bitcoin network before a bad Bitcoin node could generate a replacement transaction to steal the associated funds.

### 10. Conclusion

Other variants or use cases of the disclosed techniques may become apparent to the person skilled in the art once given the disclosure herein. The scope of the disclosure is not limited by the described embodiments but only by the accompanying claims.

For instance, some embodiments above have been described in terms of a bitcoin network 106, bitcoin blockchain 150 and bitcoin nodes 104. However it will be appreciated that the bitcoin blockchain is one particular example of a blockchain 150 and the above description may apply generally to any blockchain. That is, the present invention is in by no way limited to the bitcoin blockchain. More generally, any reference above to bitcoin network 106, bitcoin blockchain 150 and bitcoin nodes 104 may be replaced with reference to a blockchain network 106, blockchain 150 and blockchain node 104 respectively. The blockchain, blockchain network and/or blockchain nodes may share some or all of the described properties of the bitcoin blockchain 150, bitcoin network 106 and bitcoin nodes 104 as described above.

In preferred embodiments of the invention, the blockchain network 106 is the bitcoin network and bitcoin nodes 104 perform at least all of the described functions of creating, publishing, propagating and storing blocks 151 of the blockchain 150. It is not excluded that there may be other network entities (or network elements) that only perform one or some but not all of these functions. That is, a network entity may perform the function of propagating and/or storing blocks without creating and publishing blocks (recall that these entities are not considered nodes of the preferred bitcoin network 106).

In other embodiments of the invention, the blockchain network 106 may not be the bitcoin network. In these embodiments, it is not excluded that a node may perform at least one or some but not all of the functions of creating, publishing, propagating and storing blocks 151 of the blockchain 150. For instance, on those other blockchain networks a “node” may be used to refer to a network entity that is configured to create and publish blocks 151 but not store and/or propagate those blocks 151 to other nodes.

Even more generally, any reference to the term “bitcoin node” 104 above may be replaced with the term “network entity” or “network element”, wherein such an entity/element is configured to perform some or all of the roles of creating, publishing, propagating and storing blocks. The functions of such a network entity/element may be implemented in hardware in the same way described above with reference to a blockchain node 104.

It will be appreciated that the above embodiments have been described by way of example only. More generally there may be provided a method, apparatus or program in accordance with any one or more of the following Statements.

Statement 1. A computer-implemented method of implementing a hash function, HF, using blockchain transactions, wherein the method is performed by a first party and comprises:
generating a first blockchain transaction; and
submitting the first blockchain transaction to one or more nodes of a blockchain transaction,
wherein the first blockchain transaction comprises a locking script configured to, when executed together with an unlocking script of a second blockchain transaction comprising a target data item, generate a hash result of the target data item, wherein the locking script comprises a HF script configured to generate the hash result by performing at least the steps of:
   generating a first intermediate result based on a multiplication of the target data item by a first parameter,
   generating a second intermediate result based on an addition of a second parameter to the first intermediate result,
   generating a third intermediate result based on a modulo of the second intermediate result by a third parameter; and
   generating the hash result based on a modulo of the third intermediate result by a fourth parameter.

Statement 2. The method of statement 1, wherein the first locking script is configured to output at least the hash result. For instance, the hash result may be output to memory, e.g. a stack.

Statement 3. The method of statement 1 or statement 2, wherein the locking script comprises an expected hash result, and wherein the locking script is configured to require the target hash result to match the expected hash result in order to be unlocked by the unlocking script.

Statement 4. The method of statement 3, wherein the expected hash result is generated by applying the hash function to an expected public key.

Statement 5. The method of statement 4, wherein the locking script is configured to require the target data item to be the expected public key, and to comprise a signature generated using a private key corresponding to the expected public key.

Statement 6. The method of statement 4 or statement 5, comprising:
storing the expected hash result, or a shortened version thereof, in a look-up table mapped to at least one of: the expected public key, data associated with the first blockchain transaction, and/or data associated with a spending transaction that spends an output of the first blockchain transaction.

Statement 7. The method of statement 6, wherein:
the data associated with the first blockchain transaction comprises a transaction identifier of the first blockchain transaction and/or the first blockchain transaction itself; and/or
the data associated with the spending transaction comprises a transaction identifier of the spending transaction and/or the spending transaction itself.

Statement 8. The method of statement 6 or statement 7, wherein the look-up table comprises a plurality of different hash results or shortened versions thereof, each generated by applying the universal hash function to a different public key, and wherein each different hash result is mapped to at least one of: the different public key, data associated with a respective blockchain transaction comprising the different hash result, and/or data associated with a respective spending transaction that spends an output of the respective blockchain transaction.

Statement 9. The method of statement 1 or statement 2, wherein the locking script comprises a public key derivation, PKD, script configured to generate a child public key of a parent public key, wherein the PKD script comprises the HF script, and wherein the unlocking script comprises the parent public key, and wherein the target data item comprises at least a chain code of a parent public key and the parent public key, and wherein the PKD script is configured to generate the child public key based on the parent public key and the hash result. The first locking script may be configured to output the child public key.

Statement 10. The method of statement 9, wherein the target data item comprises additional data.

Statement 11. The method of statement 10, wherein the additional data comprises at least one of: an index of the child public key, a timestamp, and/or a message.

Statement 12. The method of any of statement 9 to 11, wherein the PKD script comprises a binary conversion script, a point multiplication script and a point addition script, wherein the binary conversion script is configured to covert the hash result to a binary representation, wherein the point multiplication script is configured to perform point multiplication of the binary representation of the hash result with a generator point of an elliptic curve to generate an intermediate public key, and wherein the point addition script is configured to perform point addition of the intermediate public key and the parent public key to generate the child public key.

Statement 13. The method of statement 12, wherein the hash result is represented in a decimal or hexadecimal representation, and wherein the binary conversion script is configured to convert the decimal or hexadecimal representation of the hash result to the binary representation.

Statement 14. The method of any preceding statement, wherein the first parameter is any non-zero number, the second parameter is any number, the third parameter is a positive number, and the fourth parameter is 2\hat{ }L, wherein L is chosen to define a length of the hash result.

Statement 15. The method of statement 14, wherein p is a prime number defining the sec9256k1 elliptic curve.

Statement 16. The method of statement 14 or statement 15, wherein L is one of: 32, 64, 128, 160, 256, or 512.

Statement 17. The method of any preceding statement, wherein the hash function is defined as Hash_{UHF}(P)=[aᵢP+bᵢ mod p] mod n, where aᵢ is the first parameter, bᵢ is the second parameter, p is the third parameter, and n is the fourth parameter, and wherein the method comprises:
generating a plurality of different respective expected hash results for the expected public key P by applying the hash function Hash_{UHF}(P) to the expected public key P for different respective values of one, some or all of: the first parameter, the second parameter, the third parameter, the fourth parameter.

Statement 18. The method of statement 17, wherein the first blockchain transaction comprises a plurality of respective outputs, each respective output comprising a respective locking script configured to, when executed together with a respective unlocking script of a different respective blockchain transaction comprising a respective target public key, generate a respective hash result of the respective target public key, wherein the respective locking script comprises a respective HF script configured to generate the respective hash result by performing at least the steps of:
generating a respective first intermediate result based on a multiplication of the target data item by a respective first parameter,
generating a respective second intermediate result based on an addition of a respective second parameter to the respective first intermediate result,
generating a respective third intermediate result based on a modulo of the respective second intermediate result by a respective third parameter; and
generating the respective hash result based on a modulo of the respective third intermediate result by a respective fourth parameter.
   wherein each respective locking script comprises a respective one of the plurality of expected hash results, and wherein the respective locking script is configured to a) require the respective target hash result to match the respective expected hash result, and b) require the respective unlocking script to comprise a respective signature generated using the expected public key in order to be unlocked by the unlocking script.

Statement 19. The method of statement 17 or statement 18, comprising:
generating one or more further blockchain transactions, wherein each further transaction comprises one or more respective outputs, each respective output comprising a respective locking script configured to, when executed together with a respective unlocking script of a different respective blockchain transaction comprising a respective target public key, generate a respective hash result of the respective target public key, wherein the respective locking script comprises a respective HF script configured to generate the respective hash result by performing at least the steps of:
   generating a respective first intermediate result based on a multiplication of the target data item by a respective first parameter,
   generating a respective second intermediate result based on an addition of a respective second parameter to the respective first intermediate result,
   generating a respective third intermediate result based on a modulo of the respective second intermediate result by a respective third parameter; and
   generating the respective hash result based on a modulo of the respective third intermediate result by a respective fourth parameter.
wherein each respective locking script comprises a respective one of the plurality of expected hash results, and wherein the respective locking script is configured to a) require the respective target hash result to match the respective expected hash result, and b) require the respective unlocking script to comprise a respective signature generated using the expected public key in order to be unlocked by the unlocking script.

Statement 20. The method of any of statements 17 to 19, wherein said generating of the plurality of different respective expected hash results for the expected public key P comprises i) generating a respective intermediate hash result by applying the hash function Hash_{UHF}(P) to the expected public key P for different respective values of one, some or all of: the first parameter, the second parameter, the third parameter, the fourth parameter; and ii) hashing the respective intermediate hash result with a cryptographic hash function.

Statement 21. The method of statement 20 when dependent on statement 18 or statement 19, wherein the modulo of the respective third intermediate result by the respective fourth parameter generated by the respective HF script is a respective intermediate hash result, and wherein the respective HF script is configured to generate the respective expected hash result by hashing the respective intermediate hash result with the cryptographic hash function.

Statement 22. The method of statement 20 or statement 21, wherein the cryptographic hash function is one of: RIPEMD160, SHA256, or a combination of RIPEMD160 and SHA256.

Statement 23. The method of any of statements 17 to 22, comprising:
storing the plurality of expected hash results, or a respective shortened version thereof, in a look-up table mapped to at least one of: the expected public key or an index thereof.

Statement 24. Computer equipment comprising:
memory comprising one or more memory units; and
processing apparatus comprising one or more processing units, wherein the memory stores code arranged to run on the processing apparatus, the code being configured so as when on the processing apparatus to perform the method of any preceding statement.

Statement 25. A computer program embodied on computer-readable storage and configured so as, when run on one or more processors, to perform the method of any of statement 1 to 16.

According to another aspect disclosed herein, there may be provided a method comprising the actions of the first party and the second party.

According to another aspect disclosed herein, there may be provided a system comprising the computer equipment of the first party and the second party.

1. A computer-implemented method of implementing a hash function, HF, using blockchain transactions, wherein the method is performed by a first party and comprises:
generating a first blockchain transaction; and
submitting the first blockchain transaction to one or more nodes of a blockchain network,
wherein the first blockchain transaction comprises a locking script configured to, when executed together with an unlocking script of a second blockchain transaction comprising a target data item, generate a hash result of the target data item, wherein the locking script comprises a HF script configured to generate the hash result by performing at least the steps of:
generating a first intermediate result based on a multiplication of the target data item by a first parameter,
generating a second intermediate result based on an addition of a second parameter to the first intermediate result,
generating a third intermediate result based on a modulo of the second intermediate result by a third parameter; and
generating the hash result based on a modulo of the third intermediate result by a fourth parameter.

2. The method of claim 1, wherein the first locking script is configured to output at least the hash result.

3. The method of claim 1, wherein the locking script comprises an expected hash result, and wherein the locking script is configured to require the target hash result to match the expected hash result in order to be unlocked by the unlocking script.

4. The method of claim 3, wherein the expected hash result is generated by applying the hash function to an expected public key.

5. The method of claim 4, wherein the locking script is configured to require the target data item to be the expected public key, and to comprise a signature generated using a private key corresponding to the expected public key.

6. The method of claim 4, comprising:
storing the expected hash result, or a shortened version thereof, in a look-up table mapped to at least one of: the expected public key, data associated with the first blockchain transaction, and/or data associated with a spending transaction that spends an output of the first blockchain transaction.

7. The method of claim 6, wherein:
the data associated with the first blockchain transaction comprises a transaction identifier of the first blockchain transaction and/or the first blockchain transaction itself; and/or
the data associated with the spending transaction comprises a transaction identifier of the spending transaction and/or the spending transaction itself.

8. The method of claim 6, wherein the look-up table comprises a plurality of different hash results or shortened versions thereof, each generated by applying the hash function to a different public key, and wherein each different hash result is mapped to at least one of: the different public key, data associated with a respective blockchain transaction comprising the different hash result, and/or data associated with a respective spending transaction that spends an output of the respective blockchain transaction.

9. The method of claim 1, wherein the locking script comprises a public key derivation, PKD, script configured to generate a child public key of a parent public key, wherein the PKD script comprises the HF script, and wherein the unlocking script comprises the parent public key, and wherein the target data item comprises at least a chain code of a parent public key and the parent public key, and wherein the PKD script is configured to generate the child public key based on the parent public key and the hash result.

10. The method of claim 9, wherein the target data item comprises additional data.

11. (canceled)

12. The method of claim 9, wherein the PKD script comprises a binary conversion script, a point multiplication script and a point addition script, wherein the binary conversion script is configured to covert the hash result to a binary representation, wherein the point multiplication script is configured to perform point multiplication of the binary representation of the hash result with a generator point of an elliptic curve to generate an intermediate public key, and wherein the point addition script is configured to perform point addition of the intermediate public key and the parent public key to generate the child public key.

13. The method of claim 12, wherein the hash result is represented in a decimal or hexadecimal representation, and wherein the binary conversion script is configured to convert the decimal or hexadecimal representation of the hash result to the binary representation.

14. The method of claim 1, wherein the first parameter is any non-zero number, the second parameter is any number, the third parameter is a positive number, and the fourth parameter is 2\hat{ }L, wherein L is chosen to define a length of the hash result.

15-16. (canceled)

17. The method of claim 1, wherein the hash function is defined as Hash_{UHF}(P)=[aᵢP+bᵢ mod p] mod n, where aᵢ is the first parameter, bᵢ is the second parameter, p is the third parameter, and n is the fourth parameter, and wherein the method comprises:
generating a plurality of different respective expected hash results for an expected public key P by applying the hash function Hash_{UHF}(P) to the expected public key P for different respective values of one, some or all of: the first parameter, the second parameter, the third parameter, the fourth parameter.

18. The method of claim 17, wherein the first blockchain transaction comprises a plurality of respective outputs, each respective output comprising a respective locking script configured to, when executed together with a respective unlocking script of a different respective blockchain transaction comprising a respective target public key, generate a respective hash result of the respective target public key, wherein the respective locking script comprises a respective HF script configured to generate the respective hash result by performing at least the steps of:
generating a respective first intermediate result based on a multiplication of the target data item by a respective first parameter,
generating a respective second intermediate result based on an addition of a respective second parameter to the respective first intermediate result,
generating a respective third intermediate result based on a modulo of the respective second intermediate result by a respective third parameter; and
generating the respective hash result based on a modulo of the respective third intermediate result by a respective fourth parameter.
wherein each respective locking script comprises a respective one of the plurality of expected hash results, and wherein the respective locking script is configured to a) require the respective target hash result to match the respective expected hash result, and b) require the respective unlocking script to comprise a respective signature generated using the expected public key in order to be unlocked by the unlocking script.

19. (canceled)

20. The method of claim 17, wherein said generating of the plurality of different respective expected hash results for the expected public key P comprises i) generating a respective intermediate hash result by applying the hash function Hash_{UHF}(P) to the expected public key P for different respective values of one, some or all of:
the first parameter, the second parameter, the third parameter, the fourth parameter; and ii) hashing the respective intermediate hash result with a cryptographic hash function.

21. (canceled)

22. The method of claim 21, wherein the cryptographic hash function is one of: RIPEMD160, SHA256, or a combination of RIPEMD 160 and SHA256.

23. The method of claim 17, comprising:
storing the plurality of expected hash results, or a respective shortened version thereof, in a look-up table mapped to at least one of: the expected public key or an index thereof.

24. Computer equipment comprising:
memory comprising one or more memory units; and
processing apparatus comprising one or more processing units, wherein the memory stores code arranged to run on the processing apparatus, the code being configured so as when run on the processing apparatus, the processing apparatus performs a method of implementing a hash function, HF, using blockchain transactions, wherein the method comprises:
generating a first blockchain transaction; and
submitting the first blockchain transaction to one or more nodes of a blockchain network,
wherein the first blockchain transaction comprises a locking script configured to, when executed together with an unlocking script of a second blockchain transaction comprising a target data item, generate a hash result of the target data item, wherein the locking script comprises a HF script configured to generate the hash result by performing at least the steps of:
generating a first intermediate result based on a multiplication of the target data item by a first parameter,
generating a second intermediate result based on an addition of a second parameter to the first intermediate result,
generating a third intermediate result based on a modulo of the second intermediate result by a third parameter; and
generating the hash result based on a modulo of the third intermediate result by a fourth parameter.

25. A computer program embodied on non-transitory computer-readable storage media and configured so as, when run on one or more processors, the one or more processor perform a method of implementing a hash function, HF, using blockchain transactions, wherein the method comprises:
generating a first blockchain transaction; and
submitting the first blockchain transaction to one or more nodes of a blockchain network,
wherein the first blockchain transaction comprises a locking script configured to, when executed together with an unlocking script of a second blockchain transaction comprising a target data item, generate a hash result of the target data item, wherein the locking script comprises a HF script configured to generate the hash result by performing at least the steps of:
generating a first intermediate result based on a multiplication of the target data item by a first parameter,
generating a second intermediate result based on an addition of a second parameter to the first intermediate result,
generating a third intermediate result based on a modulo of the second intermediate result by a third parameter; and
generating the hash result based on a modulo of the third intermediate result by a fourth parameter.
